(19) United States
(12) Patent Application Publication
(10) Pub. No.: US 2019/0081716 A1
(43) Pub. Date: Mar. 14, 2019

(54) POWERED MODULES AND SYSTEMS AND METHODS OF LOCATING AND REDUCING PACKET COLLISION OF SAME

(71) Applicant: Molex, LLC, Lisle, IL (US)

(72) Inventors: Jesse J. COLE, Savage, MN (US); David J. KING, Savage, MN (US)

(73) Assignee: Molex, LLC, Lisle, IL (US)

(21) Appl. No.: 15/781,210

(22) PCT Filed: Dec. 1, 2016
(86) PCT No.: PCT/US16/64425

§ 371 Date: Jun. 4, 2018

Related U.S. Application Data
(60) Provisional application No. 62/262,643, filed on Dec. 3, 2015.

(51) Int. Cl. H04H 20/86; H04H 40/27; H04W 56/00; H04W 64/00; B64D 1/02; G01S 19/34; G01S 5/02; G01S 5/14; G06Q 30/02

(52) U.S. Cl. CPC H04H 20/86; H04H 40/27; H04W 56/003; H04W 64/003; G06Q 30/0241; G01S 19/34; G01S 5/0252; G01S 5/14; B64D 1/02

(57) ABSTRACT

A system, method and/or powered module for locating a disperse set of many powered modules, conserving power of the powered modules, reducing packet collision of messages provided to/from the powered modules, and/or synchronizing the powered modules.

### CROSS-REFERENCE TO RELATED APPLICATIONS

This patent application claims the benefit of U.S. Provisional Patent Application No. 62/262,643, filed on Dec. 3, 2015, the entire content of which is incorporated by reference in its entirety.

### BACKGROUND

Recent widespread engineering and development of efforts have given rise to a system of architecture called the Internet of Things (IoT). In connection with IoT, self-powered, fully-contained electronic products communicate with other electronic devices as an autonomous system. This represents an advance over its predecessor (sometimes called the Internet of People) where electronic products can typically respond to human-generated input. The electronic products are usually dispersed over some appreciable distance from each other and the electronic products use sensors to gather data over time.

One category of valuable data that can be collected is location of each electronic product. For high-power and large form-factor electronics such as smartphones or GPS guidance units, the electronic product usually determines its own location using GPS and then displays the positions on a local display. For high-power and large form-factor electronics such as GPS tracker units, the electronic product usually determines its own location using GPS and then reports its location over the nearby cellular phone network (e.g., using GSM-based data networks is common in the United States).

A limiting factor for products that track product locations over time can be that products in today's market usually require high operating power with bulky and heavy batteries. The high power requirements make them incompatible with lightweight, low form factor, low cost electronic solutions. Further, all-in-one GPS positioning modules do not report the position of the module to a central repository, so the location of all-in-one GPS modules cannot be externally tracked. In particular it is not possible to monitor the migratory patterns of many powered modules using all-in-one GPS positioning modules, because they lack two-way wireless communication capabilities. In order to collect positioning data for a disperse distributed system of self-powered units, the power constraints require use of new techniques that consider the combined operations of determining location and wirelessly collecting location data. Products in the market today do not yet offer solutions to these power constraints for lightweight, low form factor, low cost electronic modules.

Long range low power wireless protocols are ineffective at synchronizing wirelessly connected modules to accuracies below the duration of a packet. In order to better address the unique power challenges affecting a distributed set of many thousands of powered modules, where synchronization of modules can help reduce power wasted while units wait for the RF channel to clear, the present state of the art involves modules performing a listen-before-speaking. This feature consumes significant power over time if the module continues listening due to many other modules within range. Alternatively if the module does not wait, then the packet transmitted by the module can conflict with its neighbor in a phenomenon called packet collision. Beyond the listen-before-speaking feature, synchronizing and scheduling transmission of data is not a standard feature of long range low power wireless protocols that utilize long packet durations.

### SUMMARY

There is an emerging need for strategies to prevent packet collision, and in the case of power-limited modules then strategies to improve power management of a large set of dispersed powered modules are even more needed.

In one aspect, a powered module can include a microcontroller; a data communication assembly which is configured to transmit data to, and receive data from, an associated receiver using a low-range, low-power communication protocol; a global positioning system (GPS) assembly; and a power source, the power source providing power to each of the microcontroller, the data communication assembly and the GPS assembly, wherein the microcontroller, the data communication assembly and the GPS assembly are configured to work together to receive a location request data packet from the associated receiver and, in response thereto, provide a location response data packet to the associated receiver which identifies a location of the powered module.

In one aspect, a powered module can include a microcontroller; a data communication assembly which is configured to transmit data to, and receive data from, an associated receiver using a low-range, low-power communication protocol; and a power source, the power source providing power to each of the microcontroller and the data communication assembly, wherein the microcontroller and the data communication assembly are configured to work together to receive a wake-up data packet from an associated receiver and, in response thereto, provide a plurality of response data packets at a predetermined time interval to the associated receiver.

In one aspect, a plurality of powered modules are provided, each powered module including a microcontroller, a data communication assembly and a real-time clock module, the real-time clock module of each powered module configured to be time synchronized with the real-time clock modules of the other powered modules, wherein the plurality of powered modules are separated into at least first and second sets of the plurality of powered modules, wherein the first set of the plurality of powered modules are configured to uplink data to the at least one wireless data communication gateway during a first predetermined time period, and wherein the second set of the plurality of powered modules are configured to uplink data to the at least one wireless data communication gateway during a second predetermined time period, wherein the first predetermined time period and the second predetermined time period are different.

In one aspect, a method of low-collision, wireless data communication, can include providing a plurality of powered modules, each powered module including a microcontroller, a data communication assembly, a real-time clock module, and a power source, the power source providing power to each of the microcontroller, the data communication assembly, and the real-time clock module, the real-time clock module of each powered module configured to be time synchronized with the real-time clock modules of the other powered modules; providing at least one wireless data communication; separating the plurality of powered modules into at least first and second sets of the plurality of modules; designating first and second predetermined time periods, where the first predetermined time period is different than the second predetermined time period; uplinking data from the first set of the plurality of modules to the at least one wireless data communication gateway during the first predetermined time period using a low-range, low-power communication protocol; and uplinking data from the second set of the plurality of modules to the at least one wireless data communication gateway during the second predetermined time period using the low-range, low-power communication protocol.

This Summary is provided merely for purposes of summarizing some example embodiments so as to provide a basic understanding of some aspects of the disclosure. Accordingly, it will be appreciated that the above described example embodiments are merely examples and should not be construed to narrow the scope or spirit of the disclosure in any way. Other embodiments, aspects, and advantages of various disclosed embodiments will become apparent from the following detailed description taken in conjunction with the accompanying drawings which illustrate, by way of example, the principles of the described embodiments.

### BRIEF DESCRIPTION OF DRAWINGS

FIG. 1 is a block diagram of an example powered module and example components of the powered module.

FIG. 2 is a system diagram of an example system and associated method for gathering location data from the powered module.

FIG. 3 is a block diagram of another example powered module and example components of the powered module.

FIG. 4 is a system diagram of another example system and associated method for gathering location data from the powered module.

FIG. 5 is a graph of example RSSI plots to determine a location of the powered module.

FIGS. 6A and 6B are an example system 600 and flow diagram 610, respectively, of another example for gathering location data from the powered module.

FIG. 7 is a flowchart of an example logic for collecting data during transmission windows.

FIG. 8 is a block diagram of another example powered module and example components of the powered module.

FIG. 9 is a system diagram of an example system and associated method for synchronizing powered module.

FIG. 10 is a system diagram of an example system and associated method for uplinking data.

FIG. 11 is a system diagram of an example system and associated method for downlinking data.

FIG. 12 is a block diagram of an example computing device of the powered modules.

### DESCRIPTION

An example powered module 120 is described, along with systems and methods for locating the powered module 120, conserving power of the powered module 120, reducing packet collision of messages provided to/from the powered modules 120 and/or synchronizing the powered modules 120.

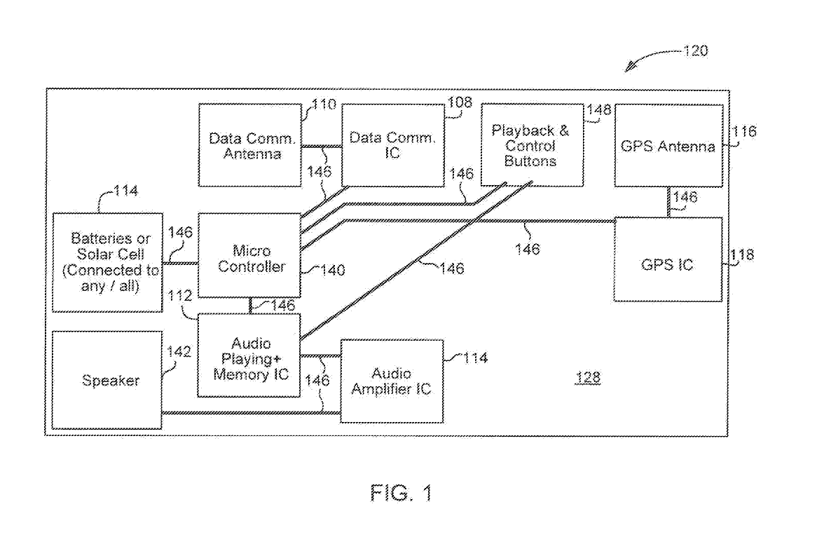

FIG. 1 is a block diagram of an example powered module 120 and example components of the powered module 120. The powered module 120 can include a microcontroller 140 connected with a data communication module 108 and data communication antenna 110 which are capable of transmitting and receiving data wirelessly. In one implementation, the microcontroller 140 is a low-powered microcontroller. In one example, the data communication IC 108 can be configured to transmit and receive data using a long-range, low-power communication protocol, such as Long Range (LoRa), or a long-range RF data transmission protocol, such as Global System for Mobile Communications (GSM) or Time Division Multiple Access (TDMA). The data communication antenna 110 can be implemented as a discrete part or as printed trace on the flexible PCB substrate 128. The data communication antenna 210 may be either a passive or active device. The microcontroller 140 may be incorporated into the data communication IC 108 or the microcontroller 140 may be a discrete element that is separate from the data communication IC 108. Example data communication antennas 110 include, but are not limited to, a trace on the printed circuit board in a configuration such as a planar inverted F-shaped antenna (commonly called PIFA) or meandering trace antenna, a chip antenna such as 2450AT42A100E by Johanson Technology, and/or a trace on an attached data communication module such as the LL-RLP-20-915-SYM-A by Link Labs or WRL-13678 by SparkFun Electronics, etc. Example data communication modules 108 include, but are not limited to, RE modules that include the data communication antenna 110, e.g., LL-RLP-20-915-SYM-A by Link Labs or WRL-13678 by SparkFun Electronics. Alternatively the data communication IC 108 may be placed directly onto the substrate 128, e.g., the Espressif ESP8266 or the Semtech SX1276, If the data communication IC 108 is placed directly onto the substrate 128, then it may require a supplemental memory module, e.g., the AT25SF041 by Adesto Technologies to hold buffer data or configuration data.

The powered module 120 can include batteries and/or solar cells 144 to scavenge available energy to power the powered module 120. Batteries or solar cells 144 can include, but are not limited to, coin cell, e.g., the CR2032 by Energizer, Ultra-thin primary cells such as the CF042039(N) by FDK, Ultra-thin cells printed onto or attached to the substrate 128 e.g., the SoftBattery by Enfucell, ultra-thin rechargeable cells, e.g., the customizable Zinc holy series by Imprint Energy, larger polymer pouch cells e.g., offerings from PowerStream and solar cell which may be flexible. These flexible options can include the flexible ELO-based GaAs offerings from Alta. Devices or the flexible silicon offerings from PowerFilm.

The powered module 120 can include playback and control buttons 148 to control playback of a message including, but not limited to: play, pause, fast-forward, rewind, next message, on or off. The powered module 120 can include an audio playing and memory integrated circuit (IC) 112 for storing the messages. In one implementation, the audio playing and memory IC 112 includes a read-only memory (ROM) whose contents can be erased and reprogrammed using a pulsed voltage, commonly referred to as EEPROM. Additionally or alternatively, the memory can include program memory, a cache, random access memory (RAM), a flash memory, a hard drive, etc., and/or other types of memory. In some implementations, the audio playing and memory IC 112 can store instructions (e.g., compiled executable program instructions, uncompiled program code, some combination thereof, or the like)), which when performed (e.g., executed, translated, interpreted, and/or the like) by the microcontroller 140, causes the microcontroller 140 to play the messages. Additionally or alternatively, the audio playing and memory IC 112 can be configured to capture an extended duration message. Audio playing and memory ICs 112 can include, but are not limited to, non-volatile memory modules, e.g., the AT24CM01-SSHM-B from Atmel (EEPROM memory type) and volatile memory modules, e.g., 23K256-I/SN by Microchip (SRAM memory type).

The powered module 120 can include one or more speakers 142 so that a user can listen to the message. Example speaker 142 can include, but is not limited to, piezoelectric ceramic offerings, e.g., APS2709S-T-R from PUI Audio Inc., and/or PVDF printed films by Molex. The powered module 120 may, for example, further include an audio amplifier IC 114 to decrease loading on the microcontroller output and/or to filter the audio signal. The audio amplifier IC 114 can include, but is not limited to, LM48860TL/NOPB from Texas Instruments. The powered module 120 is not limited to audio display of messages, and can include other modules, including but not limited to video display modules for displaying static images, animated frames, and/or full speed video. The powered module 120 may, for example, further include a video controller IC to interpret video information from the microcontroller 140 and to pass the video information to the display. A low-power display can include, but is not limited to, a segmented electrophoretic display, e.g., SC005221 by E-Ink Corporation, a pixelated electrophoretic display such as options printed by Molex, and a bar gauge such as SC002221 by E-Ink Corporation, etc. A video controller IC can include, but is not limited to, PIC24FJ128GC006-I/PT by Microchip Technology and S1C17F57F401100 by Epson Electronics, etc.

The powered module 120 can also include a GPS (global positioning system) antenna 116 and GPS IC 118. The GPS antenna 116 can be configured to collect a signal from GPS satellites. The GPS antenna 116 may be either a passive or active device. The GPS IC 118 can be configured to collect relevant GPS location (latitude, longitude, altitude) and time data from a constellation of GPS satellites through the GPS antenna 116, e.g., to be processed by the microcontroller 140. The GPS IC 118 can also be configured to return velocity to the microcontroller 140. The GPS antenna 116 can include, but is not limited to, a trace on the printed circuit board 128 in a configuration such as a planar inverted F-shaped antenna (commonly called PIFA) or meandering trace antenna and a chip antenna, e.g., the 1575AT43A0040E by Johanson Technology, etc. The GPS IC 118 can include, but is not limited to, the RXM-GPS-RM-T by Linx, alternately called an RF receiver.

The powered module 120 can include fewer, additional and/or alternate components, including but not limited to a remote charging antenna and rectifying circuit to charge batteries 144 or power the microcontroller 140. The remote charging and rectifying circuit can include, but is not limited to a discrete component including resistors, capacitors, inductors, and diodes connected to a set of printed traces 146 on the substrate 128. The traces 146 may also be tuned for desirable antenna performance parameters.

The powered module 120 can, for example, include a component, such as a field-effect transistor, for example a MOSFET, that is connected to every on-board IC or actively powered antenna, in order to turn power on or off to those parts.

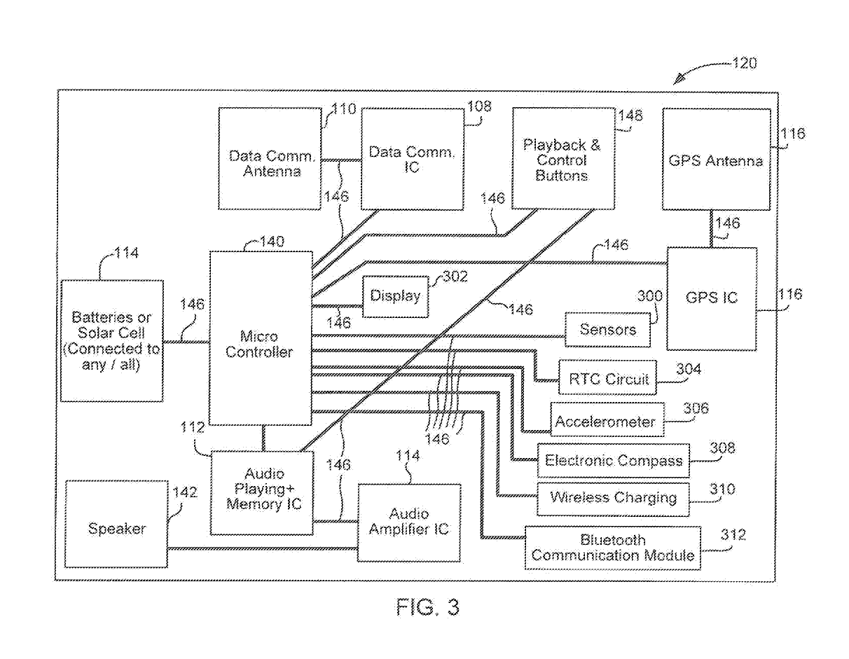

The powered module 120 may, for example, include a sensor, sensor IC, or sensor array 300 (e.g., FIG. 3) to collect data at the location of the powered module 120. A wide variety of types of data can be collected by using sensor, sensor IC and/or sensor array 300 on the powered modules 120, e.g., depending on the sensor type that is included on the module. The sensor data types can include but are not limited to temperature, humidity, vibration, mechanical shock/drop, voltage, current, magnetic field, battery health, location, lifetime, light (IR, UV, visible), radio frequency (RF) signal strength, proximity, capacitance, time, number of times that the module has been played, number of times that a button has been pressed, sound, pressure, force, weight, acceleration, chemical concentration, chemical type, solution pH, gas concentration, and/or gas type, etc. Sensor, sensor IC, sensor array 300 may include a plurality of sensors, depending on configuration of the powered module 120. Example parts include, but are not limited to, TSOP4136 infrared photodiode by Vishay, LTR-329ALS-01 ambient light sensor by Lite-On, SHT25 temperature and humidity sensor IC by Sensirion, ADXL335 MEMS accelerometer by Analog Devices, PKGS-00LDP1-R by Murata Electronics, printed silicon thermistor array by PST, Inc., and/or printed pressure array by Molex, etc.

Example applications for sensor, sensor IC and/or sensor arrays that can be included in the powered modules 120 includes, but is not limited to, remote-updateable media modules, time-varying animation displays, audio-enhanced electronic posters, transparent tamper detectors, low-visibility/camouflaged/benign-appearance electronic sensors and actuators, non-obvious listening devices, wrap-able cases for curved parts, shrinkable electronic enclosures, high aerodynamic drag objects, high transparency objects such as window-mounted sensors, heads-up display elements, immersive audio applications with a multitude of audio channels, hat or helmet-based sensing or actuation, interactive product stands or signage, human traffic monitoring, location detection, non-obvious use monitoring of seemingly passive media, asset theft detectors, parcel tracking, parcel health monitoring, smart packaging or labeling, livestock tracking, audio books or booklets utilization, individual-dependent personalized messaging, personal reminder devices, proximity tags, windshield-mounted electronic elements, pulse rate sensing, NFC data readout patches, and/or soil condition sensors, etc.

The powered module 120 can, if desired, include further components, and, if desired, in some implementations may be configured to have the full functionality of a cellular telephone. For purposes of the present disclosure as it relates to aspects of the present disclosure, powered modules 120 can further include one or more of: real-time clock circuits 304 (e.g., FIG. 3), micro-electro-mechanical systems (MEMS)-based accelerometers 306, electronic compasses 308, wireless charging capabilities 310, and/or Bluetooth Smart communication modules 312. Microcontrollers 140 can be normally operated in sleep mode to reduce their power draw. For purposes of some implementations of the present disclosure it is assumed that a position of the powered module 120 location is unknown, and the powered module 120 is not moving.

The powered module 120 can be configurable to be programmed remotely, with both uplink and downlink data transmission capabilities. The onboard data communication transceiver enables data collection from the set of media modules after they have entered use, and the media message can be reprogrammed on individual modules or on the set of all modules within transmission range.

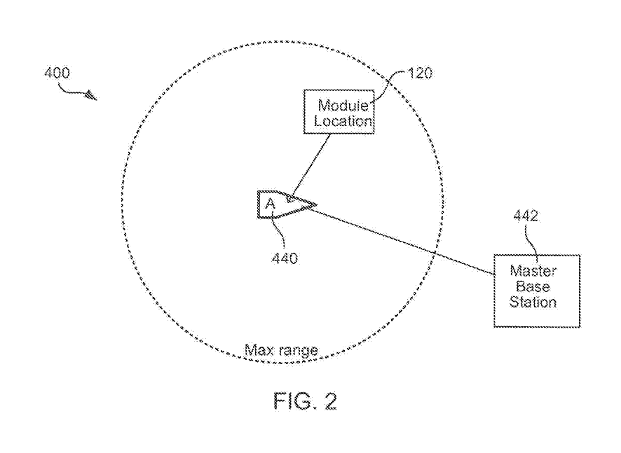

FIG. 2 is a system diagram of an example system 400 and associated method for gathering location data from the powered module 120. In one implementation, a receiver 440 (sometimes referred to as a gateway) can gather location data from a disperse set of power-limited powered modules 120 by using LoRa as a long-range, low-power communication protocol are presented. Using LoRa with unconventional positioning techniques is not obvious because the packet transmission times are long. When combined with the long time to first fix times exhibited by all-in-one GPS units, operating both LoRa and GPS simultaneously can quickly exceed power budgets. As a result, LoRa has not been implemented with positioning applications as a means for reporting location data of a disperse set of power-limited powered modules 120. Power-efficient strategies to establish the position of a large set of self-contained powered modules 120 are presented herein. In addition to location data, a variety of other data may be collected as well. The data that can be collected from a set of disperse powered modules 120 at the same time as location includes, but is not limited to, sensor data, iterated counters such as those defined by button presses, lifetime information, module health data, and received signal strength indication (RSSI) to a plurality of receivers. In the present disclosure, three exemplary configurations are provided that can be used to determine position of the powered modules 120, such that the configuration determines the type, quantity, and periodicity of data being transmitted between powered modules 120 and receivers 440. An end result is the generation of location data for one or more powered modules 120, such that this data is retrievable by collecting data from one or more receivers 440.

The powered module 120 includes microcontroller 140, which is preferably low-powered, and GPS antenna 116 and GPS IC 118. GPS assemblies can be known use a substantial amount of power. In one implementation solar cell 144 or other non-power-limited power source can be used. The GPS IC 118 may contain a low-noise amplifier, RF filters, and/or matching circuitry or these elements may be separate. The data communication IC 108 and data communication assembly 110 is capable of transmitting and/or receiving data wirelessly, e.g., using a long-range, low-power communication protocol, for example, Long-Range (LoRa). The microcontroller 140, power source, GPS assembly, and data communication assembly can be associated with one another as part of an inclusive circuit assembly and, for example, associated with one another as part of a flexible printed circuit assembly (FPCA), such that the advantages associated with using an FPCA can be realized.

The receiver 440 is configured to transmit data to, and/or receive data from, the powered module 120 using the long-range, low power communication protocol. For purposes of the present disclosure, receivers 440 (or gateways) can include: a data communication assembly which is configured to transmit and/or receive data using the same long-range, low-power communication protocol as is used by the data communication assembly of the powered module 120; onboard memory; and the capability to collect and retain data. Each receiver 440 may also include a GPS assembly. Each receiver 440 may be either self-powered or powered externally. While each receiver 440 may not know the position of every powered module 120, the data collected by all receivers 120 can reflect the complete collected data set. Each receiver 440 can also transmit data, ping powered modules 120, and/or command powered modules 120 to transmit. Depending on the arrangement, the receiver 440 can either be located in a fixed position or it can be attached to a moving object to become mobile.

Data collected by the receiver 440 can be collected in real time if the receiver 440 maintains a link to a PC or to a backend web-based server. This receiver-to-readout link can be implemented by using a wired connection over Ethernet, a wireless connection based on the GSM cellular network, or a wireless connection based on LoRa with connectivity to a master base station 442. In the latter instance, the master base station 442 is capable of collecting data over long ranges from a distributed network of receivers 440.

As an alternative to real time data collection, data collected by receivers 440 can be locally retrieved by generating a log file on the receiver's 440 onboard hard disk. Such a log file records a variety of packet information including, but not limited to: packet reception time; packet data payload; packet RSSI, and orientation. The log file can be exported to USB® flash drive, using a Secure Shell (SSH) connection over wired Ethernet, or through a Wi-Fi® connection.

In connection with the system 400 and associated methods, in a simple arrangement, the powered module 120 reports data to the receiver 440, as generally illustrated in FIG. 2. When the powered module 120 is within range of the receiver 440, the powered module 120 receives one or more location request data packets from the receiver 440. Upon receipt of the one or more location request data packets, the powered module 120 can: (a) wake from a sleep mode (so as to conserve power) (such that the location request data packets may alternatively be referred to as “wake-up” data packets); (b) turn on the GPS assembly; (c) wait for the GPS assembly to return a location; (d) transmit one or more location response data packets to the receiver 440, where the one or more location response data packets include the GPS location data of the powered module 120; and (e) return to sleep mode. It is to be understood that the system 400 and associated method can include one or more powered modules 120 and one or more receivers 440.

In the system 400 and associated method, the receiver 440 may be fixed in position or mobile. If the receiver 440 is mobile, then the receiver 440 can be moving sufficiently slowly to avoid exiting a transmission range of the powered module 120. If the receiver 440 moves too quickly, the receiver 440 may not be able to receive the one or more return data packets sent from the powered module 120.

In the system 400 and associated method, in order for the powered module 120 to receive and respond to a wake-up data packet transmitted from the receiver 440, the microcontroller 140 periodically turns on its data communication assembly into receive mode in order to listen to any external signal that may be being transmitted from the receiver 440. If no signal is present, the microcontroller 140 returns to sleep in order to conserve power.

To reduce power requirements of the GPS assembly, the one or more wake-up packets sent by the receiver 440 can pass initial limited accuracy time and location estimates to the GPS assembly. These initial estimates can eliminate reliance on the GPS assembly for downloading the complete GPS constellation almanac, which is only broadcast once every approximately 30 seconds. Reducing the startup time of the GPS assembly from approximately 30 seconds to only a few seconds to find the relevant satellites can reduce power requirements to return a location. If the receiver 440 is mobile, then decreasing a response time of the powered module 120 may also allow for faster data recovery from other modules like powered module 120.

The system 400 and method can be provided in any number of different forms.

As a first example, the system 400 and method can be utilized in connection with any type of asset tracking application. The powered module 120 can be, for example, secured to an asset to be tracked, such as a container located in a warehouse. The warehouse can also have a receiver 440 having a range which covers at least the area occupied by the warehouse. In practice, if it was necessary to locate the container in the warehouse, the receiver 440 can transmit a wake-up data packet to the powered module 420 associated with the container, which can cause the module 420 to wake from a sleep mode, turn on the GPS assembly, wait for the GPS assembly to return an exact location of the container within the warehouse, transmit one or more return data packets to the receiver 440, where the one or more return data packets include the GPS location data, and return to sleep mode. Monitoring of the receiver 440 can then provide the exact location of the container within the warehouse, without wasted time and effort. In this instance, the receiver 440 can preferably be fixed in position.

The powered module 120 can be, for example, secured to an asset to be tracked, such as a vehicle located in a city. The powered module 120 can be, for instance, hard-wired to the vehicle to receive power from the vehicle itself and/or the powered module 120 can be supplemented with power from an independent battery not associated with the vehicle such that it can act as back-up power in the event that vehicle power is not provided to the powered module 120. The city can have one or more receivers 440 having a range which covers at least the area within the confines of the city. In practice, if it was necessary to locate the vehicle in the city because, for example, the vehicle was stolen, the receiver(s) 440 can transmit a wake-up data packet to the powered module 120 associated with the stolen vehicle, which can cause the powered module 120 to wake from a sleep mode (assuming the stolen vehicle was within the range of the receiver(s) 440), turn on the GPS assembly, wait for the GPS assembly to return an exact location of the stolen vehicle within the city, transmit one or more return data packets to the receiver(s) 440, where the one or more return data packets include the GPS location data, and return to sleep mode. Monitoring of the receiver(s) 440 can then provide the exact location of the stolen vehicle within the city, without wasted time and effort. The receiver(s) 440 can be provided at the city's police station and can be fixed in position, e.g., on some type of tower, or can be mobile, e.g., on a drone controlled by the police station. Of course, it is to be understood that the stolen vehicle can have been taken out of the range of the receiver(s) 440 of the city and, therefore, it is envisioned that neighboring cities can all have one or more receivers 440, thereby effectively increasing the range of operation of the system 400. The neighboring cities can operate together to all transmit wake-up data packets from their respective receivers 440 upon the alert of a vehicle having been stolen and/or the neighboring cities can all operate together to all transmit wake-up data packets from their respective receivers 440 at predetermined dates and/or times.

As a second example, the system 400 and method can be utilized in connection with any type of air-drop application. The powered module 120 can be, for example, secured to a leaflet to be air-dropped in a target area. As the target area is an area where an air-drop scenario is necessary, it is likely that the target area does not have receiver(s) 440 fixed in place, such that the receiver(s) 440 are mobile and, for example, associated with a drone or the like. In practice, if it was necessary or desirable to locate the leaflet at some point in time after it had been air-dropped, one or more drones (each being associated with a receiver 440) can be flown above the target area, each transmitting a wake-up data packet to the powered module 120 in the form of the leaflet, which can cause the powered module 120 to wake from a sleep mode, turn on the GPS assembly, wait for the GPS assembly to return an exact location of the leaflet within the target area, transmit one or more return data packets to the receiver 440, where the one or more return data packets include the GPS location data, and return to sleep mode. Monitoring of the receivers 440 can then provide the exact location of the leaflet, thus providing information on whether the leaflet has been moved from the drop area and, if so, to where the leaflet has been moved to.

FIG. 3 is a block diagram of another example powered module and example components of the powered module. It is to be understood that the power module 120 can also include, if desired, sensors 300, buttons and/or actuators 148, speakers 142, displays 302, real-time clock circuits 304, accelerometer 306, e.g., MEMS-based, electronic compass 308, wireless charging capabilities 310 and/or Bluetooth Smart communication modules 312, etc. It is to be understood that the system 400 and associated method can include one or more powered modules 120 and one or more receivers 440.

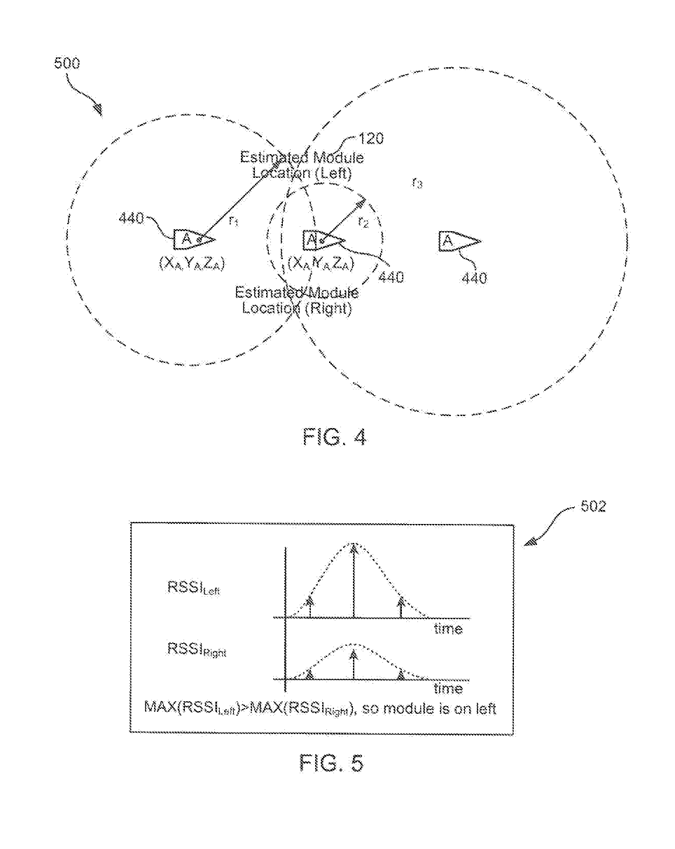

FIG. 4 is a system diagram of another example system 500 and associated method for gathering location data from the powered module 120. The system 500 and associated method provide the ability to locate a powered module 120 when the powered module 120 is not provided with an onboard GPS IC 118 or GPS antenna 116. The system 500 includes the powered module 120. The powered module 120 includes a microcontroller 140, which is preferably a low-power microcontroller. The power module 120 further includes a power source, which is preferably a battery 144. The powered module 120 further includes a data communication assembly, which preferably includes a data communication IC 108 (or transceiver) and an associated data communication antenna 110. The data communication assembly of powered module 120 is capable of transmitting and receiving data wirelessly. The data communication assembly transmits and/or receives data using a long-range, low-power communication protocol, for example, Long-Range (LoRa). The microcontroller 140 may be incorporated into the data communication module or the microcontroller 140 may be a discrete element that is separate from the data communication module. The microcontroller 140, power source 144, and data communication assembly 108, 110 are preferably associated with one another as part of an inclusive circuit assembly and more preferably, are associated with one another as part of a flexible printed circuit assembly (FPCA) of the general type discussed hereinabove, such that the advantages associated with using an FPCA can be realized.

The system 500 further includes a wireless data communication gateway or receiver 440. The receiver 440 is configured to transmit data to, and/or receive data from the powered module 120 using the long-range, low-power communication protocol, and thus has a data communication antenna associated with it. In system 500 the receiver 440, instead of the powered module 120, can include a GPS assembly, which preferably includes a GPS module and an associated GPS antenna. In the system 500 and associated method, the receiver 440 can be mobile. As the receiver 440 is mobile, the receiver 440 moves sufficiently slowly to avoid exiting a transmission range of the powered module 120. If the receiver 440 moves too quickly, the receiver 440 may not be able to receive the one or more response data packets to be sent from the powered module 120.

In connection with the system 500 and associated method; in a simple arrangement, a powered module 120 reports data to a mobile receiver 440, as generally illustrated in FIG. 4. When the powered module 120 is within range of the receiver 440, the powered module 120 can receive one or more location request data packets from the receiver 440. Upon receipt of the one or more location request data packets, the powered module 120 can: (a) wake from a sleep mode (so as to conserve power) (such that the location request data packets may alternatively be referred to as “wake-up” data packets); (b) send a plurality of response data packets to the receiver 440 at a predetermined time interval; and (c) return to sleep mode. Upon the receiver 440 receiving each response data packet, the mobile receiver 440 will: (a) measure the received signal strength indication (RSSI) for each received response data packet as it moves past the powered module 120 (the strength of the signal changes in view of the distance from the powered module 120); and (b) note its position at the time it receives each response data packet by using the GPS assembly included therein. The GPS assembly can be operated continuously and the recorded GPS data includes latitude, longitude, altitude, and velocity data.

The measured. RSSI is then converted to an estimated distance either empirically or through use of a model, as is typically done for trilateration. The standard process of converting RSSI to distance estimates assumes that LoRa radiation from the data communication antenna of the powered module 120 is nearly isotropic; with equal power radiation in all directions. This leads to an estimated circle/ellipse/sphere/spheroid/ellipsoid of distance around the mobile receiver 440 that corresponds to a particular value of RSSI.

To compensate for anisotropic radiation patterns from the data communication antenna of the powered module 120, the MEMS-based accelerometer 306 may be provided onboard the powered module 120, and the MEMS-based accelerometer 306 may be activated after receiving the wake-up (or pinging) data packet from the receiver 440. The MEMS-based accelerometer 306 may be used to estimate an orientation of the powered module 120 relative to the Earth's surface and orientation data can be communicated to the receiver 440 as a part of the response data packets in order to improve accuracy of the location of the powered module 120.

The powered module 120 may also have the electronic compass 308 provided onboard to provide information regarding module orientation.

In one embodiment, to complete the calibration routine for anisotropic radiation patterns, the data obtained from the MEMS-based accelerometer 306 can be combined with the data obtained from the electronic compass 308, and this combined data can be transmitted to the receiver 440 as well. This combined data may be communicated in a single packet or repeated for collection over multiple packets. In order to reduce the impact of handheld vibration on MEMS data, the data of the MEMS-based accelerometer 306 may be filtered over an extended period of time such that a single averaged value is returned. Data from the electronic compass 308 may be filtered in a similar way. The filtering can be performed by the microcontroller 140 or any other suitable device.

In order to further refine the estimate of the powered module 120 to mobile receiver 440 distance, additional mobile receivers 440, each with a data communication antenna 110 associated therewith, can be provided. Alternatively, if feasible, the mobile receiver 440 can be provided with a second data communication antenna, which is sufficiently separated from the first data communication antenna 110 so as to be able to differentiate location signals received by each. In such a multiple antenna, receiver node system, the directionality of each receiving antenna can be restricted to particular sectors, however a single master receiver system can involve an omnidirectional transmitting antenna to initiate the request for transmission from the powered module 120.

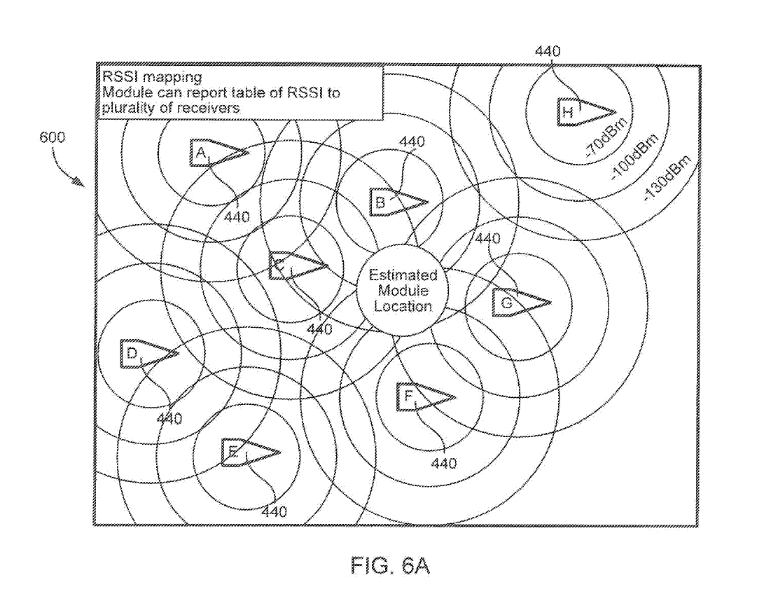

FIG. 5 is a graph 502 of example RSSI plots to determine a location of the powered module. As an example, and as generally illustrated in FIG. 5, the symmetry from left-side to right-side of the receiver node can be broken by using at least two sector-limited receiver antennae. As generally illustrated in FIG. 5, the RSSI values for the series of packets that are collected by a right-side antenna on the receiver node can be compared to those values on the left-side antenna on the receiver node, and the highest RSSI should indicate the sector where the powered module 120 is located. Additional antennae can be added to further refine the receiver 440 to powered module 120 distance estimate and essentially function as a tie-breaker when multiple sector antenna report identical RSSI values. It is to be understood that the velocity of the receiver 440 is low compared to propagation velocities for electromagnetic radiation, so Doppler effects can be minimal.

The system 500 and method can be provided in any number of different forms. As an example, the system 500 and method can be utilized in connection with any type of air-drop application. The powered module 120 can be, for example, secured to a leaflet to be air-dropped in a target area. As the target area is in an area where an air-drop scenario is necessary, it is likely that the target area cannot have receiver(s) 440 fixed in place, such that the receiver(s) 440 are preferably mobile, and preferably associated with a drone or the like. Furthermore, in most air-drop applications, it is preferable to provide for low-power consumption from the powered modules 120 and, therefore, the powered module 120, which does not utilize a GPS assembly (which uses a large amount of relative power), is ideal for such applications.

In practice, if it was necessary or desirable to locate the powered module 120 at some point in time after it had been air-dropped, a drone (being associated with a receiver 440) can be flown above the target area, transmitting a wake-up data packet to the powered module 120 in the form of the leaflet, which can cause the powered module 120 to wake from a sleep mode, send a plurality of response data packets to the receiver 440 at a predetermined time interval, and return to sleep mode. Upon the receiver 440 receiving each response data packet, the mobile receiver 440 on the drone can measure the received signal strength indication (RSSI) for each received response data packet as it moves past the powered module 120, and note its position at the time it receives each response data packet by using the GPS assembly included therein. The RSSI data for each received response data packet can then be converted to an estimated distance of the powered module 120 relative to the receiver 440, as is typically done for trilateration.

The estimated area of the powered module 120 relative to the receiver 440 provides an area in 3D as compared to the receiver 440. In order to provide a more specific comparison, e.g., splitting that 3D area in half (between left-side and right-side sectors), the receiver node (whether multiple receivers 440 each having a single antenna or a single receiver 440 having a pair of antennas), can alternatively be used. For example, in a situation where a pair of drones flying in left/right formation, each having a receiver 440 with a single antenna, are used, if the drone and associated receiver 440 provided on the left receives a stronger RSSI than the drone and associated receiver 440 provided on the right, then the ID area is cut in half and the powered module 120 is provided in the left-side sector.

It should be noted that, if the receiver 440 is not provided with the GPS assembly, the system 500 and method can still be useful to the extent that the system 500 and method can provide a relative position of the powered module 120 to the receiver 440, although it is envisioned that such a system 500 and method can provide benefits when the receiver 440 is not mobile, but rather is provided in a fixed position.

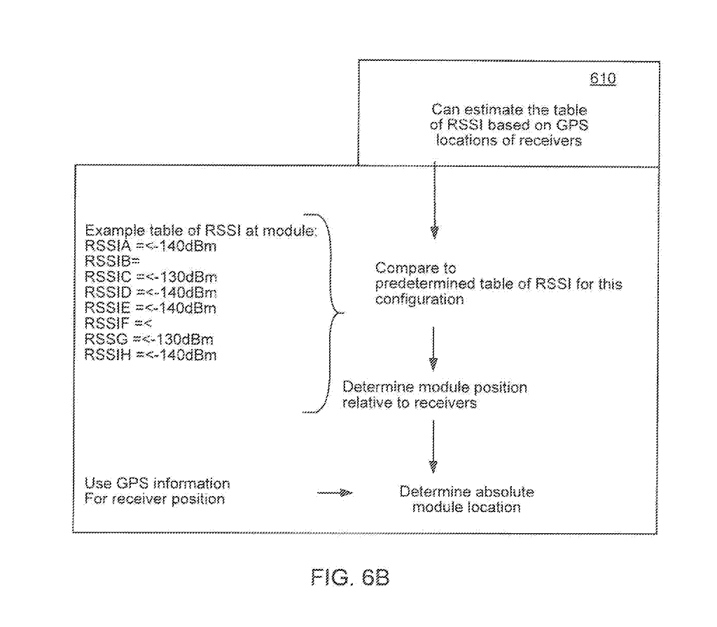

FIGS. 6A and 6B are an example system 600 and flow diagram 610, respectively, of another example for gathering location data from the powered module 120. Like system 500 and associated method, the system 600 and associated method provide the ability to locate a powered module 120 whether or not the powered module 120 is not provided with an onboard GPS assembly. A difference between the system 600 and method and the system 500 and method, is that the system 600 and method utilizes a plurality of receivers 440 distributed over an extended area in order to further refine the capability to position the powered module 120. The coverage area for each receiver 440 can overlap the coverage area for nearby receivers 440 in order to return more accurate module position data. The receivers 440 can be stationary or can be moving together as a formation.

For the case where a powered module 120 is in range of three receivers 440, the RSSI data collected by all of the receivers 440 can be used for trilateration, as is commonly used for positioning of cellular phones or other wireless communication devices. As discussed above, the effect of anisotropic module antenna radiation can be compensated by using module-based accelerometer and electronic compass devices.

For the case where a powered module 120 is in range of three or more receivers 440, RSSI mapping can be used to position the powered module 120. To perform RSSI mapping using LoRa, a precalibrated map of RSSI values for a standard powered module 120 can be predetermined empirically. As shown in FIGS. 6A and 6B, this RSSI value map can be used to fix the position of a powered module 120 relative to the formation of the receivers 440. By combining the module-to-formation data with GPS data collected by the network of receivers 440, the position of the powered module 120 can be estimated in a single data transmission from the powered module 120, as opposed to the plurality of data transmissions (response data packets) required for system 500 and method.

While a single data transmission is required from the powered module 120 of interest, the packet that is sent includes RSSI data for the full network of receivers 440. This extended data packet may correspond to a long module transmission, such that a single ping of module data should be all that is needed for determining module position. As a result, the example illustrated in FIGS. 6A and 6B may or may not involve transmission of pinging packets from the receiver 440 to the powered module 120. Instead, the powered module 120 can be initialized to wake from sleep at a set period, check for a clear network channel, then transmit a packet containing its table of RSSI values, and return to sleep. For extremely large volumes of powered modules 120 constrained within smaller area, distributing module packets over time becomes increasingly necessary. Thus, multiple fly-bys of the receiver formation may be required in order to fully collect module position data.

If specific powered module 120 location data is required, the receivers in the network can each individually send out packets containing module-specific in order to prompt the module to return RSSI map data. For the case that multiple fly-bys did not completely collect location data for every powered module 120, individual pinging a powered module (or modules) 120 of interest can be used to synchronize communication between the powered module 120 and the receiver network.

Packet collision may be an issue for situations where a large set of modules are co-located within a constrained area. As will be discussed in further detail hereinbelow, to reduce packet collision, powered modules 120 can autonomously choose to transmit on clear wireless channels only. To further avoid network congestion when attempting to collect location data from many modules, the RSSI table collected by a module can be electively reported if only a specific set of conditions have been met. For example, if the powered module has not yet been used, then location data may be considered less valuable and the powered module 120 may not report its RSSI data or location. In this case, the available wireless channels can be kept clearer by reducing the number of modules that are transmitting at a given time.

The system 600 and method can be provided in any number of different forms. As an example, the system 600 and method can be utilized in connection with any type of air-drop application. The powered module 120 can be, for example, secured to a leaflet to be air-dropped in a target area. As the target area is in an area where an air-drop scenario is necessary, it is likely that the target area cannot have receiver(s) 440 fixed in place, such that the receiver(s) 440 are preferably mobile, and preferably associated with a drone or the like. Furthermore, in most air-drop applications, it is preferable to provide for low-power consumption from the powered modules 120 and, therefore, the powered module 120, which does not utilize a GPS assembly (which uses a large amount of relative power), is ideal for such applications.

In practice, if it was necessary or desirable to locate the powered module 120 at some point in time after it had been air-dropped, a plurality of drones (each being associated with a separate receiver 440 and numbering at least three (3)) can be flown in formation above the target area. In one embodiment, the drones can transmit a wake-up data packet to the powered module 120 in the form of the leaflet, which can cause the powered module 120 to wake from a sleep mode, send a single response data packet to each of the receivers 440 (which single response data packet can include the RSSI data for each of the receivers 440), and return to sleep mode. RSSI mapping can then be used to find the location of the powered module 120. In another embodiment, it can be unnecessary for the drones to transmit a wake-up data packet, but rather the powered module 120 can be initialized to wake from sleep at a set period, check for a clear network channel, and then transmit a packet containing its table of RSSI values and return to sleep. RSSI mapping can then be used to find the location of the powered module 120.

In practice, if thousands of powered modules 120 (leaflets) had been air-dropped in a target area, it can be necessary to identify a position of one or more specific powered modules 120. In this instance, the receivers 440 can be configured to send out a wake-up data packet to the identified powered module(s) 120 in order to prompt only the identified powered module(s) 120 to return the RSSI map data.

In practice, in an effort to avoid network congestion, only those powered modules 120 (where the powered modules 120 are media modules of the general type discussed hereinabove) that have been activated such that their media message has been played may respond to the wake-up data packets and/or transmit at the predetermined times (such that those that have not been activated can remain in sleep mode).

The Internet of Things is an emerging concept where a multitude of autonomous power-limited devices can collect and transmit data wirelessly over very large dispersed areas without any human interaction. These devices may be within data transmission ranges of no other wireless devices or may be within range of many other wireless devices. The unknown and changing ecosystem of wireless devices drives the need for solutions that can preserve autonomous device functionality when out of range of any other device while also ensuring device-to-device functionality when a very high number of devices are within range.

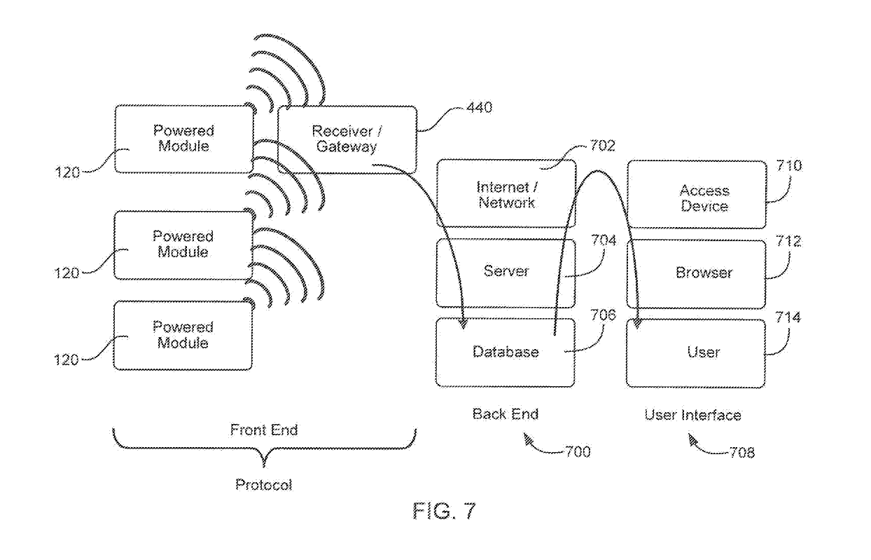

FIG. 7 is a flowchart of an example logic for collecting data during transmission windows, e.g., from sensors 300 on dispersed powered modules 120 involving transmission in the presence of a receiver 440, e.g., gateway. After information reaches the receiver 440, it is sent to a backend 700, which can include an Internet/network 702, server 704 and database 706. The information arrives at the database 706 where the data remains until a user interface 708 acts upon the collected data. The user interface 708 can include an access device 710, e.g., phone, tablet, computer, etc. and a browser 712 operating with the access device 710. The information can be viewed by a user 714.

The wireless protocol handles the media access control (MAC) layer of the network, however MAC layers are configured to prevent devices from transmitting simultaneously. This means that a device that wants to transmit can wait a long time prior to transmitting if other devices on the network are transmitting. If the devices are synchronized and programmed to transmit only during the specified window, then devices can save battery power by avoiding this wait. Even when using the SymphonyLink feature offered by Link Labs, the device would be a net power savings to pre-synchronize powered modules 120 for a particular window. Additionally, the use of a GPS module IC 118 and GPS antenna 116 allow for re-synchronization of powered modules 120 if for any reason they lose power.

The power savings by pre-synchronizing packet transmissions can be desirable for long packet duration, long-range, wide-area low-power wireless networks. There are a large number of adjustable parameters for a wireless communication system. Example parameters are included in the table below:

| Wireless Comm Parameter | Example Option for Media Module System |
|---|---|
| User Interface | Javascript/Ajax |
| Back End | Amazon (AWS) |
| Data Collection Gateway | Link Labs Gateway |
| Transceiver | Link Labs Module |
| Protocol | LoRa (LoRaWAN) |
| Layer Stack | IEEE 802.15.4 |
| Data Rate | 576 bits/10 sec |
| Modulation | FSK (CSS) |
| Topology | Star |
| Range | >4000 ft |
| Frequency | 915 MHz |

Many self-reporting devices use long-range RF data transmission protocols (such as GSM or TDMA) to report data. These protocols, which are intended for use with cellular phones, involve very short packet lengths and transmission ranges, and are effective for ranges of a few kilometers. However, these protocols require a tightly-spaced network of many high-power transceiver towers, and these towers are expensive to setup and maintain. Correspondingly, non-cellular phone device access to GSM and TDMA networks are restricted to customers of those systems.

In contrast, the lifetime cost of a distributed network can be reduced by using a third-party gateway transceiver in place of the cellular tower and by using a protocol that is friendlier to very long-range data transmission, namely where possible transmission ranges of module to gateway transceiver can exceed ten kilometers. A reduced data rate, longer duration packet-based RF communication protocol can be used to collect data over these extended distances, and fewer gateway transceivers are needed to ensure coverage.

Increases in RF transmission ranges directly contribute to the possibility for significantly more loading of devices per gateway transceiver, and when combined with the increase in packet duration, using such an RF communication protocol necessitates a more developed solution to ensure that many devices can autonomously transmit data.

While the term TDMA corresponds to a specific hardware standard and implementation presently well-used by cellular phones, a time-division multiple access approach can be implemented in any other RF communication protocol. In order to implement a system using time-division multiple access over the longest possible ranges, synchronization is needed between all transmitting powered modules 120 and the relevant receivers 440, e.g., gateway transceiver(s). The following is a way to implement time-division multiple access RF communication by synchronizing prescheduled transmission windows for a distributed set of power-limited modules.

Modern wireless communication devices can be limited to a finite set of RF channels. These channels are constrained within set frequency ranges, and transmitting devices shares the available time that is on these channels. For the case of long-range communication devices, packet durations are typically very long (typically max at up to 2 seconds, but can be even longer) and it can be challenging for the powered modules 120 to recognize that other powered modules 120 are attempting to wirelessly transmit at the same time, e.g., especially if the powered modules 120 are low-powered. Such an event where multiple powered modules 120 are simultaneously transmitting is called packet collision. Packet collision can result in data corruption, wasted power, and wasted time on the network.

A simple solution of waiting to avoid packet collision can be ineffective for a disperse set of powered modules 120. In the event that powered modules 120 recognize that nearby powered modules 120 are attempting to transmit, the very act of monitoring represents consumption of power due to the energy required to operate the long-range transceiver. Further, there can be additional power lost due to uptime on the microcontroller 140 when it is waiting instead of remaining in power-conserving sleep mode.

Another simple solution of using the real-time clock integrated circuit 304 on the powered module 120 can be ineffective due to the potential for intermittent power failure. For example, flexible batteries 144 that may be mounted on the powered module 120 commonly exhibit temporary decreases in open-circuit voltage after periods of high power draw, and after a short time the open-circuit voltage returns to nominal levels. Alternatively, in the case where the powered module 120 is powered by a photovoltaic cell (solar cell) 144 fluctuations in the light intensity onto the photovoltaic cell 144 may cause significant decreases in the open-circuit voltage as well. During these times of power droop, the real-time clock integrated circuit 304 can lose the local time and require synchronization.

Synchronizing the set of powered modules 120 can be important because the energy utilization of the entire disperse power-limited system can be significantly improved. By ensuring synchronization, individual powered modules 120 can have determined windows of opportunity to transmit their data packets with reduced chances for colliding with packets transmitted by other powered modules 120, and powered modules 120 can avoid prolonged periods of activity where modules wait for RE channels to clear.

To synchronize a disperse system of powered modules 120, it is possible to use time data collected from a GPS constellation such that this time data can be used to reset the real-time clock circuit 304 located on the powered module 120.

By synchronizing the set of powered modules 120, the data throughput of the entire set of powered modules 120 can be optimized without wasting the power of many powered modules 120 by receiving non-useful data during extended wait periods.

Each powered module 120 can synchronize itself at preset intervals autonomously in the field. This is accomplished by performing a reset of the onboard real-time clock integrated circuit 304 using GPS data collected from the onboard GPS module.

Further, if the powered module 120 does not receive a GPS signal in a preset interval then the powered module 120 can acknowledge that it is no longer synchronized with the remaining set of powered modules 120. Such a desynchronized powered module 120 can self-select to avoid transmitting packets when it is likely that the transmitted packet can result in packet collision.

Synchronized powered modules 120 use determined windows of opportunity to transmit and receive instead of continuously monitoring the available RF channels and self-determining opportune times to transmit and receive. By eliminating prolonged periods of continuously monitoring available RF channels, synchronized powered modules 120 can improve their overall power efficiency.

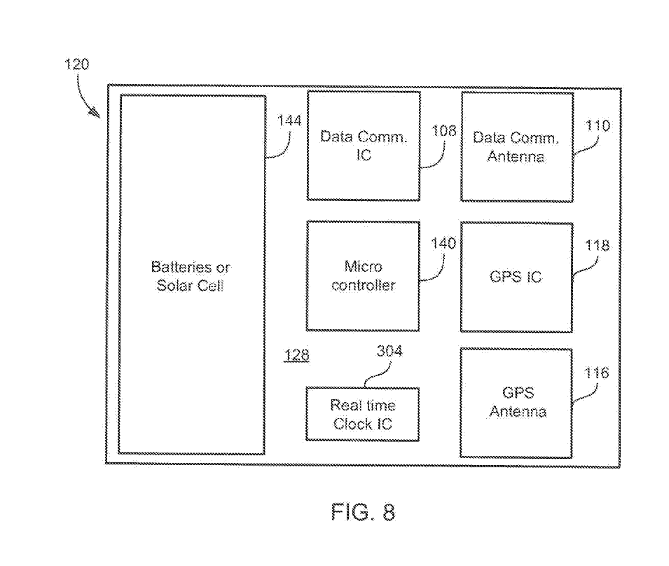

FIG. 8 is a block diagram of another example powered module 120 and example components of the powered module. The powered modules 120 may include a variety of features, including but not limited to, a printed circuit board 128, a microcontroller 140, a power-limited source of electrical energy, e.g. batteries or solar cell 144, a data communication assembly, e.g., data communication IC 108 and data communication antenna 110, a GPS module, e.g., a GPS IC 118 and GPS antenna 116, and a real-time clock integrated circuit 304. Additional or fewer components may be included, including but not limited to any of the components described herein. The printed circuit board 128 can be either rigid or flexible, but flexible may be preferred so as to take advantage of the benefits provided by an FPCA as discussed hereinabove.

The microcontroller 140 (or logic controller) can be programmed to execute determined behavior, collect data from sensors, issue commands to other integrated circuits on the powered modules 120 and interpret transmitted and/or received information. The microcontroller 140 has the capability to enter and exit a low power sleep mode. Example microcontrollers 140 include the Texas Instruments MSP430 variants.

The power-limited source of electrical energy may include one or more batteries and/or one or more solar cells 144. Therefore, some powered modules 120 can include renewable power while others do not. A characteristic of these power sources is that the supplied energy changes over time due to variations in energy consumption or production. The batteries and/or solar cells 144 can be rigid or flexible. It is to be understood that the term solar cell is to be used interchangeably with the term photovoltaic cell.

The data communication IC 108 and an associated data communication antenna 110 can transmit and receive data wirelessly. For example, this data can be transmitted or received using a long-range, low-power communication protocol, such as LoRa. The data communication module can be turned on and off by the microcontroller 140 to save power. The data communication antenna 110 may be either implemented as a discrete part or as a printed trace on the printed circuit board. The data communication antenna 110 may be either a passive device or an active device. The microcontroller 140 may be either a standalone item or may be incorporated into the data communication module.

The real-time clock IC 304 may be either a standalone component or contained within the microcontroller 140. The real-time clock IC 304 can be read and/or reset by the microcontroller 140. A timer with fixed-period oscillator may be used instead to track the passage of time, and, in the present disclosure, the time is tracked using the microcontroller 140.

A powered module 120 with a renewable power source, e.g., solar cells, may be used to provide power to the GPS IC 118 and associated GPS antenna 116 since these components are known to use a lot of power in their operation. The GPS IC 118 and associated GPS antenna 116 can determine the local time by downloading data from the GPS constellation. This data is typically referred to as the almanac. The GPS IC 118 and associated GPS antenna 116 can be turned on and off by the microcontroller 140 to save power when not in use. The GPS antenna 116 may be either implemented as a discrete part or as a printed trace on the printed circuit board. The GPS antenna 116 may be either a passive device or an active device.

The powered module 120 can be provided in any number of different forms. As an example, the powered module 120 can be utilized as an airdropped leaflet/booklet. For modules that are airdropped, the reduction in size and weight of the module represents the ability to disseminate a message contained in the module over greater distances and to more individuals. Airdropped leaflets/booklets also are not typically provided with renewable power sources for various reasons.

As another example, the powered module 120 can be utilized as a structural health monitoring module for a building, where one of the powered modules 120 can be provided in every room and/or window of a building. The powered modules 120 can be configured to operate within a system to turn lights on/off in a room, to turn heat on/off in a room. As an alternative example, the powered module 120 can be utilized in refrigeration systems in supermarkets to cause lights to turn on/off in the freezer, and/or to turn refrigeration systems on/off in the freezer, upon a door being opened.

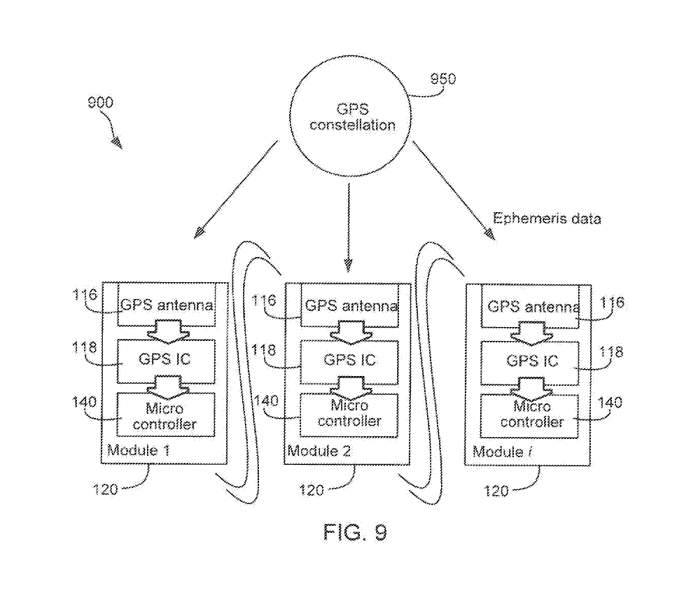

FIG. 9 is a system diagram of an example system 900 and associated method for synchronizing powered modules. The system 900 and method can synchronize the powered modules 120 in conjunction with a GPS constellation 950. For example, in the system 900 and method, the entire set of powered modules 120 can update their time at any given time. Since transmission of Ephemeris data is a broadcast type of transmission (that gives the positions of satellites in the sky) that occurs every thirty (30) seconds, the powered modules 120 can update their local time completely independently of each other, all at the same time, or with some overlap. Using the time-independence of GPS as the synchronizing event means that no uptime on the data communication IC 108 is needed for synchronization.

The GPS IC 118 (e.g., a product commercialized by Linx Technologies) is a semi-autonomous element that can be operated independently from the microcontroller 140. Thus, the GPS IC 118 can automatically search for Ephemeris data from the GPS constellation 950 after being powered on. The present status of the GPS IC 118 can be parsed by using the National Marine Electronics Association (NMEA) standard for messages over Universal Asynchronous Receiver/Transmitter (DART) connections by the microcontroller. Ephemeris data for any arbitrary satellite contains Universal Time Coordinated (UTC) time and date information down to millisecond accuracy, which data can be read and interpreted by the microcontroller 140. Datum information can be fed into the GPS IC 118 to decrease the time to find Ephemeris data. The collection of Almanac data for all satellites is not necessary to ensure accurate timekeeping.

Thus, the entire set of powered modules 120 included in the system 900 can be relied on to have synchronized time, the benefits of which have been discussed above and which is discussed in further detail below. It can be important for the powered modules 120 to be able to synchronize time across all powered modules 120 as the powered modules 120 are provided with power sources that can be subject to power droops, such that the real-time clock IC can lose the local time. Conversely, the powered modules 120, while not relying on renewable power, typically do not need to be used in the system 900 or associated method 910 as the time can be preprogrammed into the powered modules 120 and the power tends not to droop, such that the powered modules 120 are not likely to become desynchronized. However, as noted above, if flexible batteries 144 are used in the powered modules 120, the flexible batteries 144 may exhibit temporary decreases in open-circuit voltage after periods of high draw, such that it may be beneficial to use the system 900 and associated method with the powered modules 120, although then the GPS assembly can be included in the powered modules 120.

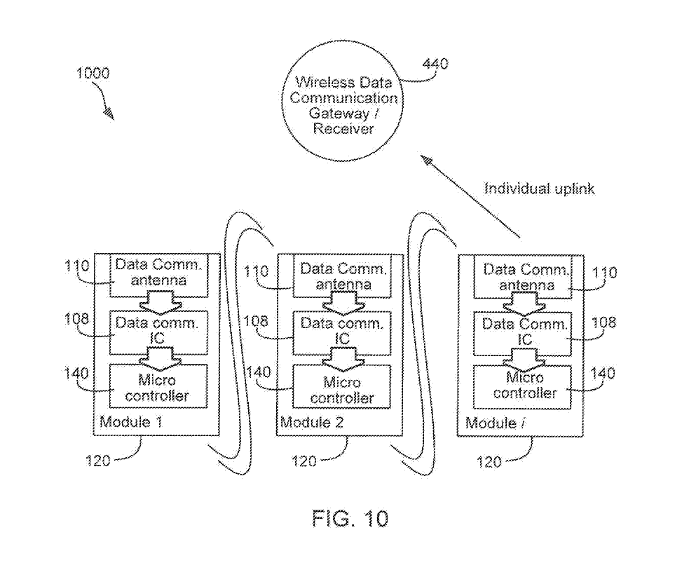

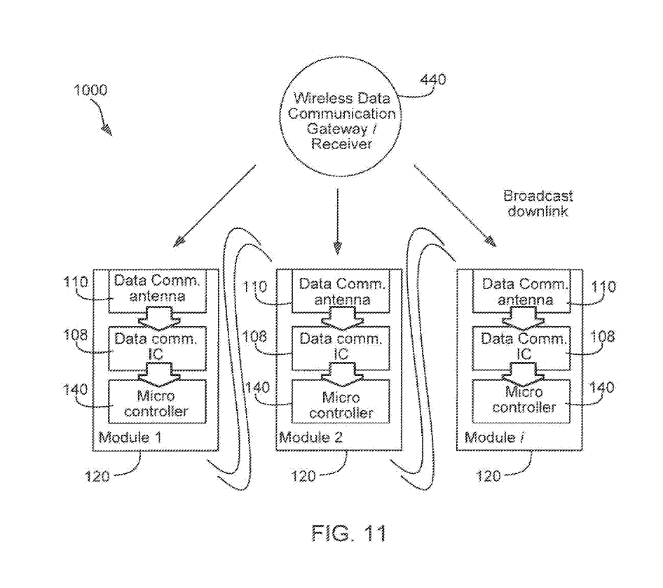

FIG. 10 is a system diagram of an example system 1000 and associated method for uplinking data. The powered modules 120 can communicate with a wireless data communication gateway and/or receiver 440. FIG. 11 is a system diagram of the example system 1000 and associated method for downlinking data. In the system 1000 and method, implementation of low-collision data communication on the wireless channel is achieved by using a set of synchronized powered modules 120. Data uplink transmissions are typically configured to be sequential for each individual powered modules 120. Data downlink transmissions are typically configured to be broadcast to the complete set of powered modules 120 that are within transmission range.

In the system 1000 and associated method, and with reference to FIG. 10, only a limited number of powered modules 120 are transmitting uplink data to the wireless data communication gateway 440 at one time. The microcontrollers 140 on only those powered modules 120 exit sleep mode and only the data communication modules 108 on those powered modules 120 are powered on. In the case of many tens of thousands of powered modules 120, this level of synchronization makes it possible to read data back from many powered modules 120. Scheduling transmission windows is especially useful for powered modules 120 where onboard power limitations negatively impact the maximum transmission power. The entire set of powered modules 120 can update their time at any given time. Since transmission of Ephemeris data is a broadcast type of transmission (that gives the positions of satellites in the sky) that occurs every thirty (30) seconds, the powered modules 120 can update their local time completely independently of each other, all at the same time, or with some overlap. Using the time-independence of GPS as the synchronizing event means that no uptime on the data communication IC 118 is needed for synchronization.

In the system 1000 and associated method, and with reference to FIG. 11, all of the synchronized powered modules 120 are listening to broadcast data from the wireless data communication gateway 440. Scheduling a window where no powered modules 120 are attempting to transmit improves the overall noise in the circuit and ensures that more powered modules 120 can respond correctly to the broadcast downlink message.

For the case where many wireless data communication gateways/receivers 440 are used, identical data transmissions can be scheduled to reach a maximum number of powered modules 120 within the disperse module set. While all powered modules 120 listen to the broadcast down link, it is possible to program powered modules 120 to respond in a customized fashion to the broadcast downlink. More specifically, it is possible to target specific powered modules 120 or groups of powered modules 120 to respond in a desired way to that message. For example, the targeted powered modules 120 can continue to listen for a more detailed message that can span many packet lengths beyond the scheduled window. In this case, where only specific powered modules 120 are targeted for a complex data downlink, then the non-targeted powered modules 120 can limit their receiving time to the original downlink window and save power by returning to sleep.

Therefore, the system 1000 can provide a low-collision, wireless data communication system and method of low-collision, wireless data communication. The system 1000 includes a plurality of powered modules 120 where each powered module 120 includes a microcontroller 140, a data communication assembly, e.g., data communication IC 108 and data communication antenna 110, a real-time clock module 304, and a power source, e.g., battery and/or solar cell 144. The power source can provide power to each of the microcontroller 140, the data communication assembly, and the real-time clock IC 304. The real-time clock IC 304 of each powered modules 120 is configured to be time synchronized with the real-time clock ICs 304 of the other powered modules 120 in the system 1000. The system 1000 further includes at least one wireless data communication gateway 440 which is configured to communication with each of the powered modules 120 using a low-range, low-power communication protocol, e.g., LoRa.

In some examples, a plurality of powered modules 120 are separated into at least first and second sets of the plurality of powered modules 120, where the first set of the plurality of powered modules 120 are configured to uplink data to the at least one wireless data communication gateway 440 during a first predetermined time period, and where the second set of the plurality of modules are configured to uplink data to the at least one wireless data communication gateway 440 during a second predetermined time period, and where the first predetermined time period is different from the second predetermined time period. The at least one wireless data communication gateway 440 may also be configured to downlink data to each of the powered modules during a third predetermined time period, and where the third predetermined time period is different from each of the first and second predetermined time periods. The method generally performs the steps as provided by the system 1000.

As discussed above, a packet duration typically lasts up to 2 seconds, but can be longer in certain instances and/or if desired. However, in a preferred embodiment and under preferred circumstances, a packet duration is considered to be no longer than 2 seconds. Thus, each of the first, second and third predetermined time periods discussed above is at least as long as a packet duration and, in a more preferred embodiment, each of the first, second and third predetermined time periods are longer than a packet duration. In a preferred embodiment, the predetermined time periods are selected to be sufficiently long to accommodate inaccuracies in the real-time clock systems on the powered modules 120. The predetermined time periods may be chosen to accommodate multiple sequential packets from the powered modules 120, depending on data requirements for the application of the system 1000. In a preferred embodiment, the predetermined time periods may also be selected to accommodate acceptance of packets from, or deliver of packets to, all powered modules 120 within a reasonable timeframe, where the timeframe is predetermined based on the application requirements.

The system 1000 and method can be provided in any number of different forms. As an example, the system 1000 and method can be utilized in connection with the powered modules 120, where the powered modules 120 are power-limited media modules which can play a media message, and where the power-limited media powered modules 120 are used in connection with an airdrop. For example, if a set of, for example, 100,000 media powered modules 120 are air dropped in a target area, each media powered module 120 that is activated, e.g., the media message is played, can send a data uplink to the wireless data communication gateway 440. However, if, for example, 80,000 of the 100,000 media powered modules 120 are activated, it may be desirable for each of the 80,000 media powered modules 120 to transmit to the wireless data communication gateway 440 at the same time. Rather, with the system 1000 and the method, the 80,000 media powered modules 120 can each have their own distinct time period during which it can transmit its data to the wireless data communication gateway 440. Preferably, sets of the media powered modules 120 can be configured to transmit at the same times, while other sets of the media powered modules 120 can be configured to transmit at one or more different times.

The 100,000 media powered modules 120 can also be configured to transmit their present location (as discussed hereinabove). In this instance, if it is determined that 20,000 of the 80,000 activated media modules are all now located at a common location within the target area, then the wireless data communication gateway 440 can broadcast a downlink to all 100,000 media modules to power down, with the exception of the 20,000 activated media modules, and that these activated media modules should continue to be powered in order to receive another one or more data packets, which may include one or more new media messages. These new media messages can then be activated again. Beneficially, each media powered modules 120 can know to not transmit data to the wireless data communication gateway 440 at one or more predetermined times when the wireless data communication gateway 440 is scheduled to broadcast a downlink to the powered modules 120.

A further system and associated method are provided. At its base, the system and associated method include at least one powered module 120 and at least one wireless data communication gateway or receiver 440. The at least one powered module 120 can include a microcontroller and a data communication assembly of the type identified hereinabove, and the microcontroller may be included as a part of the data communication assembly or may be provided as a separate discrete element. The at least one wireless data communication gateway 440 also has a microcontroller or the like and a data communication assembly. In some examples, the data communication assemblies of the at least one powered module 120 and the at least one wireless data communication gateway 440 is able to perform at least one of the following: (a) transmit data from the at least one wireless data communication gateway 440 to the at least one powered module 120 using a long-range, low-power communication protocol, preferably LoRa; (b) transmit data from the at least one powered module 120 to the at least one wireless data communication gateway and/or receiver 440 using a long-range, low-power communication protocol, preferably LoRa; and (c) transmit data back and forth between the at least one powered module 120 and the at least one wireless data communication gateway and/or receiver 440 using a long-range, low-power communication protocol, preferably LoRa (namely a combination of (a) and (b)). The long-range, low-power communication protocol preferably has possible transmission ranges of module 120 to receiver 440 that can exceed ten kilometers.

It is to be understood that any one of the modules 120 described herein may include or incorporate, where appropriate or desired, any one or more of the features described hereinabove with regard to each of modules 120.

With regard to the positioning of the receivers 440, the receivers 440 have a range of approximately 0.5 miles when the receiver 440 is positioned at ground level. The range of the receivers 440, however, increases exponentially as the position of the receivers 440 is raised off of the ground. For instance, the range of the receivers 440 when the receivers 440 are positioned at 100 feet above ground level is approximately five (5) miles, while the range of the receivers 440 when the receivers 440 are positioned at 200 feet above ground level is approximately ten (10) miles. While the receivers 440 can be provided at positions more than 200 feet above ground level, it is not preferred as increase in position also increases the surrounding noise, which can affect the transmission of signals to and from the receivers 440. Clear line of sight increases the range of the receivers 440.

With regard to the description of GPS assemblies, it is to be understood that other means of providing time and/or location to the modules and/or receivers, other than the GPS constellation, can be utilized where available. For instance, one or more receivers in a system and associated method can provide a time signal to each of the modules in the system and associated method.

A powered module can include a microcontroller; a data communication assembly which is configured to transmit data to, and receive data from, an associated receiver using a low-range, low-power communication protocol; a global positioning system (GPS) assembly; and a power source, the power source providing power to each of the microcontroller, the data communication assembly and the GPS assembly, wherein the microcontroller, the data communication assembly and the GPS assembly are configured to work together to receive a location request data packet from the associated receiver and, in response thereto, provide a location response data packet to the associated receiver which identifies a location of the powered module.

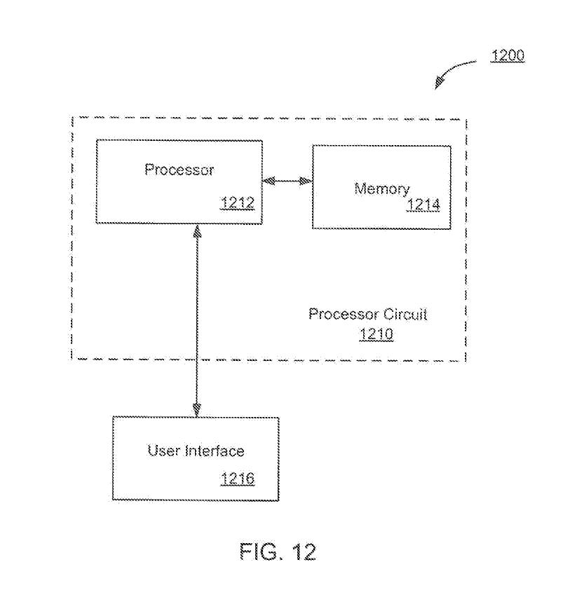

FIG. 12 is a block diagram of an example computing device 1200 of the powered modules 120. The systems and methods described above may be implemented in many different ways in many different combinations of hardware, software firmware, or any combination thereof. In one example, the computing device 1200 may enable functions of the powered module 120. It can be appreciated that the components, devices or elements illustrated in and described with respect to FIG. 12 below may not be mandatory and thus some may be omitted in certain embodiments. Additionally, some embodiments may include further or different components, devices or elements beyond those illustrated in and described with respect to FIG. 12.

In some example embodiments, the computing device 1200 may include processing circuitry 1210 that is configurable to perform actions in accordance with one or more example embodiments disclosed herein. In some examples the processing circuitry 1210 includes the microcontroller 140 or other processor. The processing circuitry 1210 may be configured to perform and/or control performance of one or more functionalities of the powered module 120. The processing circuitry 1210 may be configured to perform data processing, application execution and/or other processing and management services according to one or more example embodiments. In some embodiments, the computing device 1200 or a portion(s) or component(s) thereof, such as the processing circuitry 1210, may include one or more chipsets and/or other components that may be provided by integrated circuits.

In some example embodiments, the processing circuitry 1210 may include a processor 1212 and, in some embodiments, such as that illustrated in FIG. 12, may further include memory 1214. The processor 1212 may be embodied in a variety of forms. For example, the processor 1212 may be embodied as various hardware-based processing means such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it can be appreciated that the processor 1212 may include a plurality of processors. The plurality of processors may be in operative communication with each other and may be collectively configured to perform one or more functionalities of the computing device as described herein. In some example embodiments, the processor 1212 may be configured to execute instructions that may be stored in the memory 1214 or that may be otherwise accessible to the processor 1212. As such, whether configured by hardware or by a combination of hardware and software, the processor 1212 is capable of performing operations according to various embodiments while configured accordingly.

In some example embodiments, the memory 1214 may include one or more memory devices. Memory 1214 may include fixed and/or removable memory devices. In some embodiments, the memory 1214 may provide a non-transitory computer-readable storage medium that may store computer program instructions that may be executed by the processor 1212. In this regard, the memory 1214 may be configured to store information, data, applications, instructions and/or the like for enabling the computing device to carry, out various functions in accordance with one or more example embodiments. In some embodiments, the memory 1214 may be in communication with one or more of the processor 1212, the user interface 1216 for passing information among components of the computing device 1200. In some examples the user interface 1216 includes the playback and control buttons 148.

In one aspect, the data communication assembly only transmits a location response data packet to the associated receiver after receiving a transmitted location request data packet from the associated receiver.

In one aspect, in order to conserve power, the powered module normally operates in a sleep mode and periodically turns on the data communication assembly in order to listen for a signal from the associated receiver.

In one aspect, the power source is a battery.

In one aspect, the low-range, low-power communication protocol is Long-Range (LoRa).

In one aspect, the microcontroller is provided as a part of the data communication assembly.

In one aspect, a location system includes at least one powered module, each powered module including a microcontroller, a data communication assembly, a global positioning system (GPS) assembly, and a power source, the power source providing power to each of the microcontroller, the data communication assembly and the GPS assembly, wherein the microcontroller, the data communication assembly and the GPS assembly are configured to work together; and at least one receiver which is configured to communicate with the data communication assembly of the at least one power module using a low-range, low-power communication protocol, wherein the at least one receiver is configured to transmit one or more location request data packets to the at least one powered module, and, in response to receiving the one or more location request data packets, the at least one powered module transmits one or more location response data packets to the at least one receiver, wherein the one or more location response data packets includes a location of the at least one powered module.

In one aspect, in response to receiving the one or more location request data packets from the at least one receiver, the at least one powered module can wake from sleep mode, turn on the GPS assembly, wait for the GPS assembly to return a location, send the GPS location data to the at least one receiver, and return to sleep mode.

In one aspect, the one or more location request data packets include initial time and location estimates to be passed to the GPS assembly, thereby eliminating the need for the GPS assembly to download a complete GPS constellation almanac, thereby reducing power requirements of the GPS assembly.

In one aspect, the at least one receiver is fixed in position.

In one aspect, the at least one receiver is associated with a tower.

In one aspect, the at least one receiver is mobile.

In one aspect, the at least one receiver is associated with a drone.

In one aspect, the microcontroller is provided as a part of the data communication assembly.

In one aspect, the at least one receiver maintains a link to a PC or to a backend web-based server, and wherein the location response data packets received by the at least one receiver are collected in real time.

In one aspect, the link is implemented by using one of a wired connection over Ethernet, a wireless connection based on the GSM cellular network, and a wireless connection based on LoRa with connectivity to a master base station; wherein the master base station is configured to collect data over long ranges from a distributed network of receivers.

In one aspect, the location response data packets received by the at least one receiver are locally retrieved by generating a log file on an onboard hard disk of the at least one receiver.

In one aspect, the log file records a variety of information regarding the location response data packets including one or more of packet reception time, packet data payload, packet RSSI, and orientation.

In one aspect, the log file is configured to be exported by one of a USB flash drive; use of a secure SSH connection over wired Ethernet, and through a Wi-Fi connection.

In one aspect, a method of locating a powered module can include providing a receiver which is configured to communicate with the powered module using a low-range, low-power communication protocol; transmitting a location request data packet from a receiver to a data communication assembly associated with a power module; transmitting information from the location request data packet from the data communication assembly, to a microcontroller associated with the power module; turning on a GPS assembly associated with the power module; transmitting information from the location request data packet from the microcontroller to the GPS assembly; obtaining a location of the power module using the GPS assembly; transmitting a location response data packet from the GPS assembly to the microcontroller, wherein the location response data packet includes the location of the power module; turning off the GPS assembly; transmitting the location response data packet from the microcontroller to the data communication assembly; and transmitting the location response data packet to the receiver.

In one aspect, the data communication assembly only transmits a location response data packet to the receiver upon receiving a transmission from the receiver which includes a location request data packet.

In one aspect, prior to transmitting the location request data packet from the receiver to the data communication assembly, periodically waking the microcontroller from a sleep mode and turning on the data communication assembly.

In one aspect, after transmitting the location response data packet to the receiver, turning off the data communication assembly and returning the microcontroller to the sleep mode.

In one aspect, the location request data packet includes initial time and location estimates to be passed to the GPS assembly, thereby eliminating the need for the GPS assembly to download a complete GPS constellation almanac, thereby reducing power requirements of the GPS assembly.

In one aspect, a powered module can include a microcontroller; a data communication assembly which is configured to transmit data to, and receive data from, an associated receiver using a low-range, low-power communication protocol; and a power source, the power source providing power to each of the microcontroller and the data communication assembly, wherein the microcontroller and the data communication assembly are configured to work together to receive a wake-up data packet from an associated receiver and, in response thereto, provide a plurality of response data packets at a predetermined time interval to the associated receiver.

In one aspect, the data communication assembly only transmits the plurality of response data packets to the associated receiver after receiving a transmitted wake-up data packet from the associated receiver.

In one aspect, in order to conserve power, the powered module normally operates in a sleep mode and periodically turns on the data communication assembly in order to listen for a signal from the associated receiver.

In one aspect, the microcontroller is provided as a part of the data communication assembly.

In one aspect, a location system can include a powered module, the powered module including a microcontroller, a data communication assembly, and a power source, the power source providing power to each of the microcontroller and the data communication assembly, wherein the microcontroller and the data communication assembly are configured to work together; and at least one receiver which is configured to communicate with the data communication assembly of the powered module using a low-range, low-power communication protocol, wherein the at least one receiver is configured to transmit one or more wake-up data packets to the powered module, and, in response to receiving the one or more wake-up data packets, the powered module transmits a plurality of response data packets to the at least one receiver at a predetermined time interval, wherein the at least one receiver measures an associated received signal strength (RSSI) for each transmitted response data packet and converts same to an estimated distance to provide a zone in which the powered module is located relative to the at least one receiver.

In one aspect, the at least one receiver includes a GPS assembly, wherein upon receiving the plurality of response data packets from the powered modules, the at least one receiver measures an associated RSSI for each transmitted response data packet and notes its position at the time it received each response data packet by using the GPS assembly.

In one aspect, the powered module further includes a MEMS-based accelerometer.

In one aspect, the powered module further includes an electronic compass.

In one aspect, the at least one receiver is mobile.

In one aspect, each receiver is associated with a drone.

In one aspect, in order to conserve power, the powered module normally operates in a sleep mode and periodically turns on the data communication assembly in order to listen for a signal from the at least one receiver.

In one aspect, the power source is a battery.

In one aspect, the low-range, low-power communication protocol is Long-Range (LoRa).

In one aspect, the microcontroller is provided as a part of the data communication assembly.

In one aspect, a single receiver is provided which has first and second antennas associated therewith, each of the first and second antennas being positioned relative to one another such that each of the first and second antennas can receive the plurality of response data packets, and the measured RSSI from each antenna can be different.

In one aspect; a pair of receivers are provided which each have a single antenna associated therewith, each receiver being positioned relative to one another such that the antennas of each receiver can receive the plurality of response data packets, and the measured RSSI from each antenna can be different.

In one aspect, a method of locating a powered module can include providing a first receiver which is configured to communicate with the powered module using a low-range, low-power communication protocol; transmitting a wake-up data packet from the first receiver to a data communication assembly associated with a power module; transmitting a plurality of response data packets at a predetermined time interval from the data communication assembly associated with the power module to the first receiver; measuring a received signal strength indication (RSSI) for each response data packet at the receiver relative to the powered module; and converting the RSSI to an estimated distance between the powered module and the receiver, to thereby define a location zone of the powered module relative to the receiver.

In one aspect, further taking a GPS location of the receiver at the times when it receives each response data packet.

In one aspect, the receiver is mobile.

In one aspect, the receiver is associated with a drone.

In one aspect, further compensating for anisotropic radiation patterns from an antenna of the powered module.

In one aspect, the compensating step is performed by a MEMS-based accelerometer associated with the powered module.

In one aspect, the compensating step is performed by an electronic compass associated with the powered module.

In one aspect, the first receiver has first and second antennas associated therewith, each antenna each of the first and second antennas being positioned relative to one another such that each of the first and second antennas can receive the plurality of response data packets, and the measured RSSI from each antenna can be different.

In one aspect, first and second receivers are provided which each have a single antenna associated therewith, each receiver being positioned relative to one another such that the antennas of each receiver can receive the plurality of response data packets, and the measured RSSI from each antenna can be different.

In one aspect, the data communication assembly only transmits the plurality of response data packets to the receiver upon receiving a transmission from the receiver which includes the wake-up data packet.

In one aspect, in order to conserve power, the powered module normally operates in a sleep mode and periodically turns on the data communication assembly in order to listen for a signal from the first receiver.

In one aspect, the power source is a battery.

In one aspect, the low-range, low-power communication protocol is Long-Range (LoRa).

In one aspect, the microcontroller is provided as a part of the data communication assembly.

In one aspect, a powered module can include a microcontroller; a data communication assembly which is configured to transmit data to a plurality of associated receivers using a low-range, low-power communication protocol; and a power source, the power source providing power to each of the microcontroller and the data communication assembly, wherein the microcontroller and the data communication assembly are configured to work together provide at least one response data packet to each of the associated receivers.

In one aspect, the data communication assembly is configured to receive data from the plurality of associated receivers using a low-range, low-power communication protocol, and wherein the microcontroller and the data communication assembly are configured to work together to receive at least one wake-up packet from the plurality of associated receivers.

In one aspect, in order to conserve power, the powered module normally operates in a sleep mode and periodically turns on the data communication assembly in order to listen for a signal from the plurality of associated receivers.

In one aspect, the at least one response data packet includes RSSI data for each of the receivers.

In one aspect, the power source is a battery.

In one aspect, the low-range, low-power communication protocol is Long-Range (LoRa).

In one aspect, the microcontroller is provided as a part of the data communication assembly.

In one aspect, a location system can include a powered module, the powered module including a microcontroller, a data communication assembly, and a power source, the power source providing power to each of the microcontroller and the data communication assembly, wherein the microcontroller and the data communication assembly are configured to work together; and at least three receivers, each receiver being configured to communicate with the data communication assembly of the powered module using a low-range, low-power communication protocol, wherein the powered module is configured to transmit a single response data packet to each of the receivers, the single response data packet having RSSI data for each of the receivers, wherein a location of the powered module can be determined based on the RSSI data and a location of each receiver.

In one aspect, the location of each receiver is pre-programmed as each receiver is fixed in position.

In one aspect, each receiver is mobile.

In one aspect, each receiver is associated with a drone.

In one aspect, each receiver includes a GPS assembly, wherein upon receiving the RSSI data from the powered module, the at least one receiver measures an associated RSSI for each transmitted response data packet and notes its position at the time it received each response data packet by using the GPS assembly.

In one aspect, the power source is a battery.

In one aspect, the low-range, low-power communication protocol is Long-Range (LoRa).

In one aspect, the microcontroller is provided as a part of the data communication assembly.

In one aspect, the powered module is configured to transmit a single response data packet to each of the receivers in response to a wake-up data packet transmitted by each of the receivers.

In one aspect, further including a plurality of powered modules.

In one aspect, each receiver can be configured to transmit a wake-up data packet to one or more of the plurality of powered modules.

In one aspect, each powered module is configured to autonomously choose to transmit the response data packet on clear wireless channels only.

In one aspect, each powered module is configured to only transmit the response data packet if one or more conditions have been met.

In one aspect, the powered module is a media module having a message to be played, and wherein a condition required to have been met is the message having been played.

In one aspect, a method of locating a powered module can include providing at least three receivers which are configured to communicate with at least one powered module using a low-range, low-power communication protocol; determining a location of each receiver; transmitting a response data packet from the data communication assembly associated with the power module to each of the receivers, wherein each response data packet has RSSI data for each of the receivers; and calculating a location of the powered module based on the RSSI data.

In one aspect, the location of each receiver is pre-programmed as each receiver is fixed in position.

In one aspect, further providing each receiver with a GPS assembly; and determining the location of each receiver using the GPS assembly at a time when each respective receiver receives the response data packet.

In one aspect, the receiver is mobile.

In one aspect, the receiver is associated with a drone.

In one aspect, further compensating for anisotropic radiation patterns from an antenna of the powered module.

In one aspect, the compensating step is performed by a MEMS-based accelerometer associated with the powered module.

In one aspect, the compensating step is performed by an electronic compass associated with the powered module.

In one aspect; the low-range, low-power communication protocol is Long-Range (LoRa).

In one aspect, a plurality of powered modules are provided.

In one aspect, thousands of powered modules are provided.

In one aspect, hundreds of thousands of powered modules are provided.

In one aspect, each receiver transmits a wake-up data packet to less than the plurality of powered modules.

In one aspect, each receiver transmits the wake-up data packet to a single one of the powered modules.

In one aspect, each powered module autonomously chooses to transmit the response data packet on clear wireless channels only.

In one aspect, each powered module only transmits the response data packet if one or more conditions have been met.

In one aspect, the powered module is a media module having a message to be played, and wherein a condition required to have been met is the message having been played.

In one aspect, a powered module, the powered module includes a microcontroller; a data communication assembly which is configured to wirelessly transmit data to, and receive data from, an associated receiver using a low-range, low-power communication protocol; and a real-time clock module; and a power source, the power source providing power to each of the microcontroller, the data communication assembly, and the real-time clock module, wherein the microcontroller, the data communication assembly and the real-time clock module are configured to work together to either transmit a data packet to the associated receiver or receive a data packet from the associated receiver during a predetermined time period.

In one aspect, the long-range, low-power communication protocol is Long-Range (LoRa).

In one aspect, the microcontroller is programmed to execute predetermined behavior, including, collecting data from sensors, issuing commands to other integrated circuits forming a part of the powered module, and interpreting transmitted and/or received information.

In one aspect, the microcontroller has the capability to enter and exit a low power sleep mode.

In one aspect, the power source is one or more batteries.

In one aspect, the one or more batteries are flexible printed batteries.

In one aspect, the data communication assembly includes a data communication module and an associated data communication antenna.

In one aspect, the data communication module can be turned on and off by the microcontroller in order to save power.

In one aspect, the data communication antenna is implemented as a discrete part or as a printed trace on a circuit board.

In one aspect, the data communication antenna is either a passive device or an active device.

In one aspect; the real-time clock module is implemented as either a discrete part or is contained within the microcontroller.

In one aspect; the real-time clock module can be read and/or reset by the microcontroller.

In one aspect, the real-time clock module is a timer with fixed-period oscillator that is used to track the passage of time, and wherein the time is tracked using the microcontroller.

In one aspect, further including a time signal assembly, wherein the power source provides power to the time signal assembly.

In one aspect, the time signal assembly is a GPS assembly.

In one aspect, the GPS assembly includes a GPS module and an associated GPS antenna.

In one aspect, the GPS module is capable of determining the local time by downloading data from the GPS constellation.

In one aspect, the GPS module can be turned on and off by the microcontroller to save power.

In one aspect, the GPS antenna is implemented as a discrete part or as a printed trace on a circuit board.

In one aspect, the GPS antenna is either a passive device or an active device.

In one aspect, a time synchronization system includes a device which is configured to broadcast time signals; and a plurality of powered modules, each powered module being required to perform an action at a predetermined time, each powered module having a microcontroller, a real-time clock module, a time signal assembly, and a power source, the power source providing power to each of the microcontroller, the real-time clock module, and the time signal assembly, wherein the time signal assembly of each powered module is configured to receive one or more of the broadcasted time signals from the device to ensure that the real-time clock module has an accurate time, thereby causing each of the powered modules to have synchronized times such that the powered modules can each perform their respective actions at their respective predetermined times.

In one aspect, the device is a GPS constellation, and wherein the time signal assembly of each powered module is a GPS assembly.

In one aspect, further including at least one wireless data communication gateway, and wherein each powered module has a data communication assembly which is configured to wirelessly transmit data to, and receive data from, the at least one wireless data communication gateway using a low-range, low-power communication protocol, and wherein the action to be performed by each powered module is one of transmitting data to, or receiving data from, the at least one wireless data communication gateway.

In one aspect, each powered module is configured to receive one or more of the broadcasted time signals from the device one of completely independent from the other powered modules, at the same time as the other powered modules, or with some overlap with the other powered modules.

In one aspect, the time signal assembly is a semi-autonomous element which is operated independently from the microcontroller, such that the time signal assembly can automatically search for the broadcasted time signals after being powered on.

In one aspect, the broadcasted time signals are Ephemeris data.

In one aspect, the Ephemeris data can be read and interpreted by the microcontroller.

In one aspect, datum information can be fed into the time signal assembly in order to decrease the time to find Ephemeris data.

In one aspect, the time signal assembly is a GPS assembly, and wherein the device is the GPS constellation.

In one aspect, the power source is a renewable power source.

In one aspect, the renewable power source is one or more solar cells.

In one aspect, a method of synchronizing time on a set of powered modules can include providing the set of powered modules, each powered module having a microcontroller, a real-time clock module, a time signal assembly, and a power source, the power source providing power to each of the microcontroller, the real-time clock module, and the time signal assembly; causing each powered module to locate a device which is configured to broadcast time signals; receiving one or more of the broadcasted time signals from the device to ensure that each powered module has an accurate time, thereby ensuring that each powered module is time synchronized.

In one aspect, each powered module is required to perform an action at a predetermined time, further causing each of the powered modules to perform their respective actions at their respective predetermined times.

In one aspect, further including at least one wireless data communication gateway, and wherein each powered module has a data communication assembly which is configured to wirelessly transmit data to, and receive data from, the at least one wireless data communication gateway using a low-range, low-power communication protocol, and wherein the action to be performed by each powered module is one of transmitting data to, or receiving data from, the at least one wireless data communication gateway.

In one aspect; the device is a GPS constellation; and wherein the time signal assembly of each powered module is a GPS assembly.

In one aspect, each powered module is configured to receive one or more of the broadcasted time signals from the device one of completely independent from the other powered modules, at the same time as the other powered modules, or with some overlap with the other powered modules.

In one aspect, the time signal assembly is a semi-autonomous element which is operated independently from the microcontroller, such that the time signal assembly can automatically search for the broadcasted time signals after being powered on.

In one aspect, the broadcasted time signals are Ephemeris data.

In one aspect, the Ephemeris data can be read and interpreted by the microcontroller.

In one aspect, datum information can be fed into the time signal assembly in order to decrease the time to find Ephemeris data.

In one aspect, the time signal assembly is a GPS assembly, and wherein the device is the GPS constellation.

In one aspect, the power source is a renewable power source.

In one aspect, the renewable power source is one or more solar cells.

In one aspect, a system includes a plurality of powered modules, each module including a microcontroller, a data communication assembly, a real-time clock module, and a power source, the power source providing power to each of the microcontroller, the data communication assembly, and the real-time clock module, the real-time clock module of each powered module configured to be time synchronized with the real-time clock modules of the other powered modules; at least one wireless data communication gateway which is configured to communicate with each of the powered modules using a low-range, low-power communication protocol, wherein the plurality of powered modules are separated into at least first and second sets of the plurality of modules, wherein the first set of the plurality of modules are configured to uplink data to the at least one wireless data communication gateway during a first predetermined time period, and wherein the second set of the plurality of modules are configured to uplink data to the at least one wireless data communication gateway during a second predetermined time period, wherein the first predetermined time period and the second predetermined time period are different.

In one aspect, at least one wireless data communication gateway is configured to downlink data to each of the powered modules during a third predetermined time period, wherein the third predetermined time period is different from each of the first and second predetermined time periods.

In one aspect, in response to receiving the downlink data from the at least one wireless data communication gateway, a first group of the powered modules is instructed to receive further downlink data from the at least one wireless data communication gateway during a fourth predetermined time period, and a second group of the powered modules is not instructed to receive further downlink data from the at least one wireless data communication gateway during the fourth predetermined time period, wherein the fourth predetermined time period is different from each of the first, second and third predetermined time periods.

In one aspect, the first group of the powered modules includes one or more of the powered modules, and wherein the second group of the powered modules includes one or more of the powered modules.

In one aspect, the microcontrollers of the second group of the powered modules go into a sleep mode and the data communication assemblies of the second group of the powered modules are powered off during the fourth predetermined time period.

In one aspect, the plurality of powered modules numbers in the thousands.

In one aspect, each uplink of data during the first predetermined time period is defined to have a maximum packet duration time, and wherein the first predetermined time period is at least as long as the maximum packet duration time.

In one aspect, the maximum packet duration time is two seconds.

In one aspect, each uplink of data during the second predetermined time period is defined to have a maximum packet duration time, and wherein the second predetermined time period is at least as long as the maximum packet duration time.

In one aspect, the maximum packet duration time is two seconds.

In one aspect, each downlink of data during the third predetermined time period is defined to have a maximum packet duration time, and wherein the third predetermined time period is at least as long as the maximum packet duration time.

In one aspect, the maximum packet duration time is two seconds.

In one aspect, the plurality of powered modules numbers in the thousands.

In one aspect, each uplink of data during the first predetermined time period is defined to have a maximum packet duration time, and wherein the first predetermined time period is at least as long as the maximum packet duration time.

In one aspect, the maximum packet duration time is two seconds.

In one aspect, each uplink of data during the second predetermined time period is defined to have a maximum packet duration time, and wherein the second predetermined time period is at least as long as the maximum packet duration time.

In one aspect, the maximum packet duration time is two seconds.

In one aspect, the microcontrollers of the first set of the powered modules go into a sleep mode and the data communication assemblies of the first set of the powered modules are powered off during the second predetermined time period.

In one aspect, the microcontrollers of the second set of the powered modules go into a sleep mode and the data communication assemblies of the second set of the powered modules are powered off during the first predetermined time period.

In one aspect, the microcontroller of each powered module is a part of the data communication assembly of each powered module.

In one aspect, the power source is one or more batteries.

In one aspect, the one or more batteries are flexible batteries.

In one aspect, the power source is one or more batteries and one or more solar cells.

In one aspect, the power source is one or more solar cells.

In one aspect, the power source is a renewable power source.

In one aspect; the low-range, low-power communication protocol is Long-Range (LoRa).

In one aspect; the at least one wireless data communication gateway is fixed in position.

In one aspect, the at least one wireless data communication gateway is mobile.

In one aspect, the time synchronization of the real-time clock modules of each of the powered modules occurs when the microcontrollers of each of the powered modules are programmed.

In one aspect, each of the powered modules has a time signal assembly, and wherein the time synchronization of the real-time clock modules of each of the powered modules occurs by the time signal assemblies periodically receiving time signals from at least one device which broadcasts time signals.

In one aspect, the time signal assembly of each powered module is a GPS assembly, and wherein the at least one device which broadcasts time signals is a GPS constellation.

In one aspect, a method of low-collision, wireless data communication, can include providing a plurality of powered modules, each powered module including a microcontroller, a data communication assembly, a real-time clock module, and a power source, the power source providing power to each of the microcontroller, the data communication assembly, and the real-time clock module, the real-time clock module of each powered module configured to be time synchronized with the real-time clock modules of the other powered modules; providing at least one wireless data communication; separating the plurality of powered modules into at least first and second sets of the plurality of modules; designating first and second predetermined time periods, where the first predetermined time period is different than the second predetermined time period; uplinking data from the first set of the plurality of modules to the at least one wireless data communication gateway during the first predetermined time period using a low-range, low-power communication protocol; and uplinking data from the second set of the plurality of modules to the at least one wireless data communication gateway during the second predetermined time period using the low-range, low-power communication protocol.

In one aspect, further designating a third predetermined time period, wherein the third predetermined time period is different from the first and second predetermined time periods; and downlinking data from the at least one wireless data communication gateway to each of the powered modules during the third predetermined time period using the low-range, low-power communication protocol.

In one aspect, further causing a first group of the powered modules, in response to the downlinked data received during the third predetermined time period, to receive further downlink data from the at least one wireless data communication gateway during a fourth predetermined time period using the low-range, low-power communication protocol, wherein the fourth predetermined time period is different from each of the first, second and third predetermined time periods; and causing a second group of the powered modules, in response to the downlinked data received during the third predetermined time period, to not receive further downlink data from the at least one wireless data communication gateway during the fourth predetermined time period.

In one aspect, the first group of the powered modules includes one or more of the powered modules, and wherein the second group of the powered modules includes one or more of the powered modules.

In one aspect, the microcontrollers of the second group of the powered modules go into a sleep mode and the data communication assemblies of the second group of the powered modules are powered off during the fourth predetermined time period.

In one aspect, the plurality of powered modules numbers in the thousands.

In one aspect, each uplink of data during the first predetermined time period is defined to have a maximum packet duration time, and wherein the first predetermined time period is at least as long as the maximum packet duration time.

In one aspect, the maximum packet duration time is two seconds.

In one aspect, each uplink of data during the second predetermined time period is defined to have a maximum packet duration time, and wherein the second predetermined time period is at least as long as the maximum packet duration time.

In one aspect, the maximum packet duration time is two seconds.

In one aspect; each downlink of data during the third predetermined time period is defined to have a maximum packet duration time, and wherein the third predetermined time period is at least as long as the maximum packet duration time.

In one aspect, the maximum packet duration time is two seconds.

In one aspect, the plurality of powered modules numbers in the thousands.

In one aspect, each uplink of data during the first predetermined time period is defined to have a maximum packet duration time, and wherein the first predetermined time period is at least as long as the maximum packet duration time.

In one aspect, the maximum packet duration time is two seconds.

In one aspect, each uplink of data during the second predetermined time period is defined to have a maximum packet duration time, and wherein the second predetermined time period is at least as long as the maximum packet duration time.

In one aspect, the maximum packet duration time is two seconds.

In one aspect, the microcontrollers of the first set of the powered modules go into a sleep mode and the data communication assemblies of the first set of the powered modules are powered off during the second predetermined time period.

In one aspect, the microcontrollers of the second set of the powered modules go into a sleep mode and the data communication assemblies of the second set of the powered modules are powered off during the first predetermined time period.

In one aspect, the microcontroller of each powered module is a part of the data communication assembly of each powered module.

In one aspect, the power source is one or more batteries.

In one aspect, one or more batteries are flexible batteries.

In one aspect, the power source is one or more batteries and one or more solar cells.

In one aspect, the power source is one or more solar cells.

In one aspect, the power source is a renewable power source.

In one aspect, the low-range, low-power communication protocol is Long-Range (LoRa).

In one aspect, the at least one wireless data communication gateway is fixed in position.

In one aspect, the at least one wireless data communication gateway is mobile.

In one aspect, the time synchronization of the real-time clock modules of each of the powered modules occurs when the microcontrollers of each of the powered modules are programmed.

In one aspect, each of the powered modules has a time signal assembly, and wherein the time synchronization of the real-time clock modules of each of the powered modules occurs by the time signal assemblies periodically receiving time signals from at least one device which broadcasts time signals.

In one aspect, the time signal assembly of each powered module is a GPS assembly, and wherein the at least one device which broadcasts time signals is a GPS constellation.

In one aspect, the data transmission system includes at least one wireless data communication gateway; and at least one powered module, wherein the at least one wireless data communication gateway is configured to transmit data to the at least one powered module, and/or wherein the at least one powered module is configured to transmit data to the at least one wireless data communication gateway; wherein the transmission of data uses a long-range, low-power communication protocol.

In one aspect, the long-range, low-power communication protocol is Long-Range (LoRa).

In one aspect, the long-range, low-power communication protocol does not include GSM and CDMA.

In one aspect, a plurality of powered modules are provided, wherein each powered module is a media module, wherein each media module includes a microcontroller and a data communication assembly, the data communication assembly being configured to receive data from the microcontroller; the data communication assembly being configured to transmit data to the microcontroller.

In one aspect, the microcontroller is configured to have a media message programmed therein, and wherein each media module further includes a playback device and an initiation device, the playback device being configured to play the media message, the initiation device being configured to cause the playback device to play the media message.

In one aspect, the at least one powered module includes a microcontroller, a data communication assembly, and a global positioning system (GPS) assembly, wherein the at least one wireless data communication gateway is configured to transmit one or more location request data packets to the at least one powered module and, in response to receiving the one or more location request data packets, the at least one powered module transmits one or more location response data packets to the at least one wireless data communication gateway, wherein the one or more location response data packets includes a location of the at least one powered module.

In one aspect, in response to receiving the one or more location request data packets from the at least one wireless data communication gateway, the at least one powered module can wake from a sleep mode, turn on the GPS assembly, wait for the GPS assembly to return a location, send the GPS location data to the at least one wireless data communication gateway, and return to the sleep mode.

In one aspect, the at least one powered module includes a microcontroller and a data communication assembly, wherein the at least one wireless data communication gateway is configured to transmit one or more wake-up data packets to the at least one powered module and, in response to receiving the one or more wake-up data packets, the at least one powered module transmits a plurality of response data packets to the at least one wireless data communication gateway at a predetermined time interval, wherein the at least one wireless data communication gateway measures an associated received signal strength (RSSI) for each transmitted response data packet and converts same to an estimated distance to provide a zone in which the at least one powered module is located relative to the at least one wireless data communication gateway.

In one aspect, the at least one powered module includes a microcontroller and a data communication assembly, wherein at least three wireless data communication gateways are provided, and wherein the at least one powered module is configured to transmit a single response data packet to each of the at least three wireless data communication gateways, the single response data packet having RSSI data for each of the at least three wireless data communication gateways, wherein a location of the at least one powered module can be determined based on the RSSI data and a location of each wireless data communication gateway.

In one aspect, a plurality of powered modules are provided, each powered module including a microcontroller, a data communication assembly and a real-time clock module, the real-time clock module of each powered module configured to be time synchronized with the real-time clock modules of the other powered modules, wherein the plurality of powered modules are separated into at least first and second sets of the plurality of powered modules, wherein the first set of the plurality of powered modules are configured to uplink data to the at least one wireless data communication gateway during a first predetermined time period, and wherein the second set of the plurality of powered modules are configured to uplink data to the at least one wireless data communication gateway during a second predetermined time period, wherein the first predetermined time period and the second predetermined time period are different.

In one aspect, the at least one wireless data communication gateway is configured to downlink data to each of the powered modules during a third predetermined time period, wherein the third predetermined time period is different from each of the first and second predetermined time periods.

In one aspect, the time synchronization of the real-time clock modules of each powered module occurs when the microcontrollers of each of the powered modules are programmed.

In one aspect, each of the powered modules has a time signal assembly, and wherein the time synchronization of the real-time clock modules of each of the powered modules occurs by the time signal assemblies periodically receiving time signals from at least one device which broadcasts time signals.

In one aspect, the time signal assembly of each powered module is a GPS assembly, and wherein the at least one device which broadcasts time signals is a GPS constellation.

In one aspect, the at least one power module includes a power source.

In one aspect, the power source is a renewable power source.

In one aspect, the power source is a non-renewable power source.

In one aspect, the power source is one or more batteries.

In one aspect, the power source is one or more flexible batteries.

In one aspect, the power source is one or more solar cells.

In one aspect, the power source is a combination of one or more batteries and one or more solar cells.

In one aspect, a method of data transmission, the method comprising the steps of: providing at least one wireless data communication gateway; providing at least one powered module; transmitting data from one of the at least one wireless data communication gateway and the at least one powered module to the other one of the at least one wireless data communication gateway and the at least one powered module using a long-range, low-power communication protocol.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

1-41. (canceled)

42. A location system comprising:
a powered module, the powered module including a microcontroller, a data communication assembly, and a power source, the power source providing power to each of the microcontroller and the data communication assembly, wherein the microcontroller and the data communication assembly are configured to work together; and
at least one receiver which is configured to communicate with the data communication assembly of the powered module using a long range, low-power communication protocol,
wherein the at least one receiver is configured to transmit one or more wake-up data packets to the powered module, and, in response to receiving the one or more wake-up data packets, the powered module transmits a plurality of response data packets to the at least one receiver at a predetermined time interval, wherein the at least one receiver measures an associated received signal strength (RSSI) for each transmitted response data packet and converts same to an estimated distance to provide a zone in which the powered module is located relative to the at least one receiver.

43. A location system according to claim 42, wherein the at least one receiver is fixed in position.

44. A location system according to claim 42, wherein the at least one receiver includes a GPS assembly, wherein upon receiving the plurality of response data packets from the powered modules, the at least one receiver measures an associated RSSI for each transmitted response data packet and notes its position at the time it received each response data packet by using the GPS assembly.

45. A location system according to claim 44, wherein the powered module further includes a MEMS-based accelerometer.

46. A location system according to claim 44, wherein the powered module further includes an electronic compass.

47. A location system according to claim 44, wherein the at least one receiver is mobile.

48. A location system according to claim 47, wherein each receiver is associated with a drone.

49. A location system according to claim 44, wherein, in order to conserve power, the powered module normally operates in a sleep mode and periodically turns on the data communication assembly in order to listen for a signal from the at least one receiver.

50. A location system according to claim 44, wherein the power source is a battery.

51. A location system according to claim 44, wherein the long range, low-power communication protocol is Long-Range (LoRa).

52. A location system according to claim 44, wherein the microcontroller is provided as a part of the data communication assembly.

53. A location system according to claim 44, wherein a single receiver is provided which has first and second antennas associated therewith, each of the first and second antennas being positioned relative to one another such that each of the first and second antennas will receive the plurality of response data packets, and the measured RSSI from each antenna will be different.

54. A location system according to claim 44, wherein a pair of receivers are provided which each have a single antenna associated therewith, each receiver being positioned relative to one another such that the antennas of each receiver will receive the plurality of response data packets, and the measured RSSI from each antenna will be different.

55-76. (canceled)

77. A location system comprising:
a powered module, the powered module including a microcontroller, a data communication assembly, and a power source, the power source providing power to each of the microcontroller and the data communication assembly, wherein the microcontroller and the data communication assembly are configured to work together; and
at least three receivers, each receiver being configured to communicate with the data communication assembly of the powered module using a long range, low-power communication protocol,
wherein the powered module is configured to transmit a single response data packet to each of the receivers, the single response data packet having RSSI data for each of the receivers, wherein a location of the powered module can be determined based on the RSSI data and a location of each receiver.

78. A location system according to claim 77, wherein the location of each receiver is pre-programmed as each receiver is fixed in position.

79. A location system according to claim 77, wherein each receiver is mobile.

80. A location system according to claim 79, wherein each receiver is associated with a drone.

81. A location system according to claim 79, wherein each receiver includes a GPS assembly, wherein upon receiving the RSSI data from the powered module, the at least one receiver measures an associated RSSI for each transmitted response data packet and notes its position at the time it received each response data packet by using the GPS assembly.

82. A location system according to claim 77, wherein the power source is a battery.

83. A location system according to claim 77, wherein the long range, low-power communication protocol is Long-Range (LoRa).

84. A location system according to claim 77, wherein the microcontroller is provided as a part of the data communication assembly.

85. A location system according to claim 77, wherein the powered module is configured to transmit a single response data packet to each of the receivers in response to a wake-up data packet transmitted by each of the receivers.

86. A location system according to claim 77, further comprising a plurality of powered modules.

87. A location system according to claim 86, wherein each receiver can be configured to transmit a wake-up data packet to one or more of the plurality of powered modules.

88. A location system according to claim 86, wherein each powered module is configured to autonomously choose to transmit the response data packet on clear wireless channels only.

89. A location system according to claim 86, wherein each powered module is configured to only transmit the response data packet if one or more conditions have been met.

90. A location system according to claim 89, wherein the powered module is a media module having a message to be played, and wherein a condition required to have been met is the message having been played.

91-234. (canceled)
